(19) United States
(12) Patent Application Publication
(10) Pub. No.: US 2026/0319222 A1
(43) Pub. Date: Oct. 15, 2026

(54) OPTICAL SYSTEM AND IMAGE PICKUP APPARATUS INCLUDING THE SAME

(71) Applicant: CANON KABUSHIKI KAISHA, Tokyo (JP)

(72) Inventors: Kento TSUCHIYA, Tochigi (JP); Makoto NAKAHARA, Tochigi (JP)

(21) Appl. No.: 19/635,850

(22) Filed: Apr. 1, 2026

(30) Foreign Application Priority Data
Apr. 9, 2025 (JP) 2025-064387

(51) Int. Cl. G02B 13/00; G02B 7/04; G02B 9/08; G02B 9/64; H04N 23/55

(52) U.S. Cl. CPC G02B 13/0045; G02B 7/04; G02B 9/08; G02B 9/64; H04N 23/55

(57) ABSTRACT

Provided is an optical system including a positive first lens unit which does not move during focusing, and a positive second lens unit which moves on an optical axis during focusing arranged in order from an object side to an image side. Only the second lens unit moves during focusing. A total number of lenses included in the optical system is nine or less. A negative lens is arranged closest to the object side in the first lens unit. An average value of refractive indices of all lenses included in the second lens unit, a focal length of the second lens unit, a focal length of a lens having a largest absolute value of the focal length among the all lenses included in the second lens unit, a total optical length of the optical system, and a focal length of the optical system are appropriately set.

### BACKGROUND

### Field of the Technology

The present disclosure is related to an optical system and an image pickup apparatus including the optical system, and particularly to an optical system suitably used in an image pickup apparatus such as a digital video camera, a digital still camera, a silver-halide film camera, a broadcasting camera, or a monitoring camera.

### Description of the Related Art

In recent years, an optical system used in an image pickup apparatus is required to be compact and lightweight as a whole and to have a high optical performance capable of sufficiently correcting a chromatic aberration.

In addition, it is important that an optical system suitable for picking-up a moving image is provided with a focusing unit that is quiet during focusing and is lightweight in order to suppress an occurrence of vibration.

Here, in order to suppress occurrences of noise and vibration with maintaining the high optical performance, it is important to set the focusing unit to have a compact and lightweight configuration and to appropriately set a lens configuration of each lens unit.

Japanese Patent Laid-Open No. 2023-168803 discloses an optical system consists of a first lens unit having a positive refractive power which does not move during focusing, a second lens unit having a negative refractive power which moves along an optical axis during the focusing, and a third lens unit having a positive refractive power which does not move during the focusing, in order from an object side to an image side.

In the optical system disclosed in Japanese Patent Laid-Open No. 2023-168803, a large number of lenses are provided in order to satisfactorily correct a lateral chromatic aberration and a field curvature, so that downsizing is not sufficiently achieved.

### SUMMARY

Accordingly, the present disclosure provides an optical system which is provided with a lightweight focusing unit which is suitable for picking-up a moving image and is quiet and less likely to vibrate, and which has a high optical performance capable of satisfactorily correcting various aberrations including the lateral chromatic aberration and the field curvature, and an image pickup apparatus including the optical system.

An optical system according to one aspect of the present disclosure includes a first lens unit which does not move during focusing and has a positive refractive power, and a second lens unit which moves on an optical axis during focusing and has a positive refractive power arranged in order from an object side to an image side, in which only the second lens unit moves during focusing, a total number of lenses included in the optical system is nine or less, a negative lens is arranged closest to the object side in the first lens unit, and following inequalities are satisfied:

1.45<Nave2<1.67

−0.80<f2/f2lp<0.60

2.20<TD/f<5.50

where Nave2 represents an average value of refractive indices of all lenses included in the second lens unit with respect to a d-line, f2 represents a focal length of the second lens unit, f2lp represents a focal length of a first lens having a largest absolute value of the focal length among the all lenses included in the second lens unit, TD represents a total optical length of the optical system, and f represents a focal length of the optical system.

Features of the present disclosure will become apparent from the following description of embodiments with reference to the attached drawings. The following description of embodiments is described by way of example.

### BRIEF DESCRIPTION OF THE DRAWINGS

FIG. 1 is a cross sectional view of an optical system according to Example 1 when focusing on infinity.

FIG. 2 is aberration diagrams of the optical system according to Example 1 when focusing on infinity.

FIG. 3 is aberration diagrams of the optical system according to Example 1 when focusing on a closest distance.

FIG. 4 is a cross sectional view of an optical system according to Example 2 when focusing on infinity.

FIG. 5 is aberration diagrams of the optical system according to Example 2 when focusing on infinity.

FIG. 6 is aberration diagrams of the optical system according to Example 2 when focusing on a closest distance.

FIG. 7 is a cross sectional view of an optical system according to Example 3 when focusing on infinity.

FIG. 8 is aberration diagrams of the optical system according to Example 3 when focusing on infinity.

FIG. 9 is aberration diagrams of the optical system according to Example 3 when focusing on a closest distance.

FIG. 10 is a cross sectional view of an optical system according to Example 4 when focusing on infinity.

FIG. 11 is aberration diagrams of the optical system according to Example 4 when focusing on infinity.

FIG. 12 is aberration diagrams of the optical system according to Example 4 when focusing on a closest distance.

FIG. 13 is a cross sectional view of an optical system according to Example 5 when focusing on infinity.

FIG. 14 is aberration diagrams of the optical system according to Example 5 when focusing on infinity.

FIG. 15 is aberration diagrams of the optical system according to Example 5 when focusing on a closest distance.

FIG. 16 is a cross sectional view of an optical system according to Example 6 when focusing on infinity.

FIG. 17 is aberration diagrams of the optical system according to Example 6 when focusing on infinity.

FIG. 18 is aberration diagrams of the optical system according to Example 6 when focusing on a closest distance.

FIG. 19 is a cross sectional view of an optical system according to Example 7 when focusing on infinity.

FIG. 20 is aberration diagrams of the optical system according to Example 7 when focusing on infinity.

FIG. 21 is aberration diagrams of the optical system according to Example 7 when focusing on a closest distance.

FIG. 22 is a cross sectional view of an optical system according to Example 8 when focusing on infinity.

FIG. 23 is aberration diagrams of the optical system according to Example 8 when focusing on infinity.

FIG. 24 is aberration diagrams of the optical system according to Example 8 when focusing on a closest distance.

FIG. 25 is a cross sectional view of an optical system according to Example 9 when focusing on infinity.

FIG. 26 is aberration diagrams of the optical system according to Example 9 when focusing on infinity.

FIG. 27 is aberration diagrams of the optical system according to Example 9 when focusing on a closest distance.

FIG. 28 is a perspective view of an image pickup apparatus provided with the optical system according to any one of Examples 1 to 9.

### DESCRIPTION OF THE EMBODIMENTS

Hereinafter, an optical system according to the present disclosure is described in detail with reference to the accompanying drawings. Note that the drawings described below may be drawn on a scale different from the actual scale in order to facilitate understanding of the present disclosure.

Further, in a single cemented lens consisting of N lenses cemented together, the number of lenses is defined to be N.

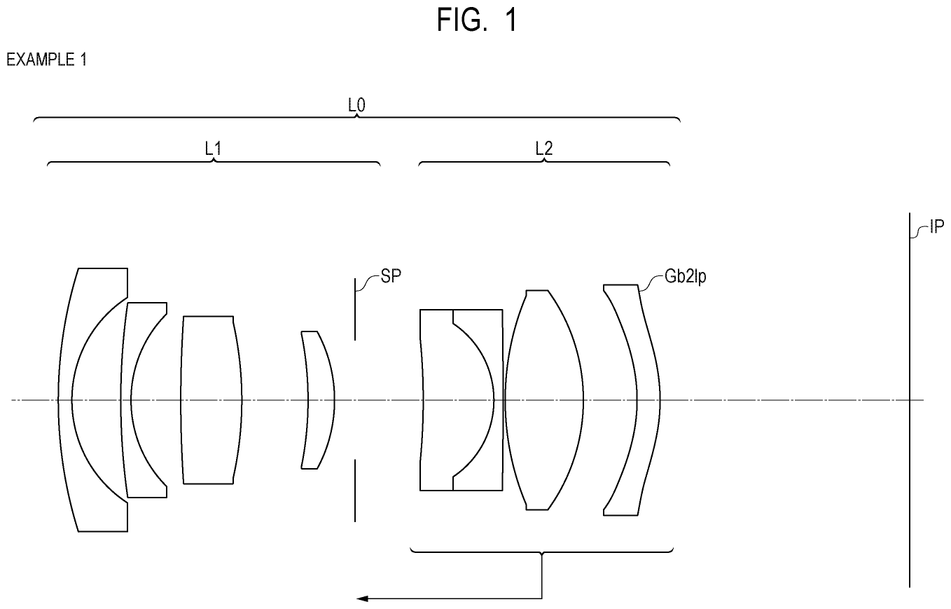

FIGS. 1, 4, 7, 10, 13, 16, 19, 22 and 25 show schematic cross sectional views of optical systems L0 according to Examples 1, 2, 3, 4, 5, 6, 7, 8 and 9 when focusing on infinity, respectively.

Specifically, the optical system L0 according to each of Examples 1 to 9 is used in an image pickup apparatus such as a digital video camera, a digital still camera, a silver-halide film camera, a broadcasting camera, or a monitoring camera, but is not limited thereto.

In FIGS. 1, 4, 7, 10, 13, 16, 19, 22 and 25, the left side is an object side, and the right side is an image side.

The optical system L0 according to each of Examples 1 to 9 is formed by a plurality of lens units.

Note that the lens unit referred to here is a single lens or a plurality of lenses that moves integrally or is stationary (immobile) during focusing, and may include an aperture stop SP.

That is, in the optical system L0 according to each of Examples 1 to 9, an interval between the lens units adjacent to each other changes during focusing from infinity to a closest distance.

Specifically, in FIGS. 1, 4, 7, 10, 13, 16, 19, 22 and 25, Li (i is a positive integer) represents an i-th lens unit counted from the object side among the plurality of lens units included in the optical system L0.

Among them, a first lens unit L1 has a positive refractive power, and a second lens unit L2 has a positive refractive power. SP represents an aperture stop, and IP represents an image plane.

When the optical system L0 according to each of Examples 1 to 9 is used as an image pickup optical system in a digital still camera or a digital video camera, an image pickup surface of a solid-state image pickup element (photoelectric conversion element) such as a CCD sensor or a CMOS sensor is arranged at a position of the image plane IP.

On the other hand, when the optical system L0 according to each of Examples 1 to 9 is used as an image pickup optical system in a silver-halide film camera, a photosensitive surface corresponding to a film surface is arranged at the position of the image plane IP.

Arrows relating to focusing shown in FIGS. 1, 4, 7, 10, 13, 16, 19, 22 and 25 indicate a moving direction of the second lens unit L2 during focusing from infinity to the closest distance.

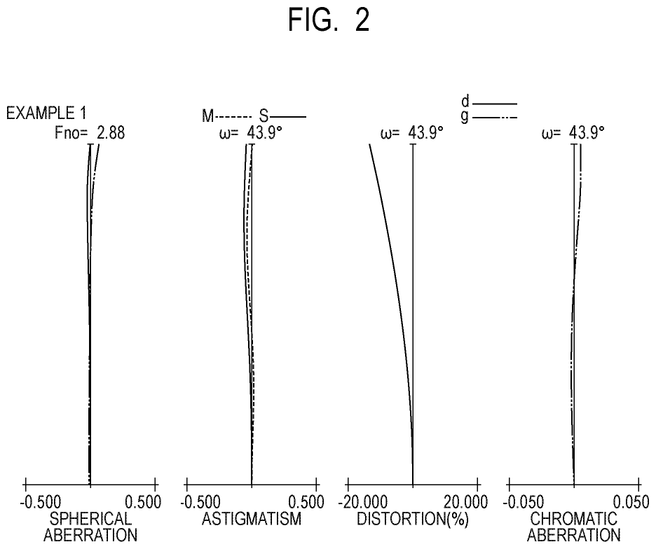

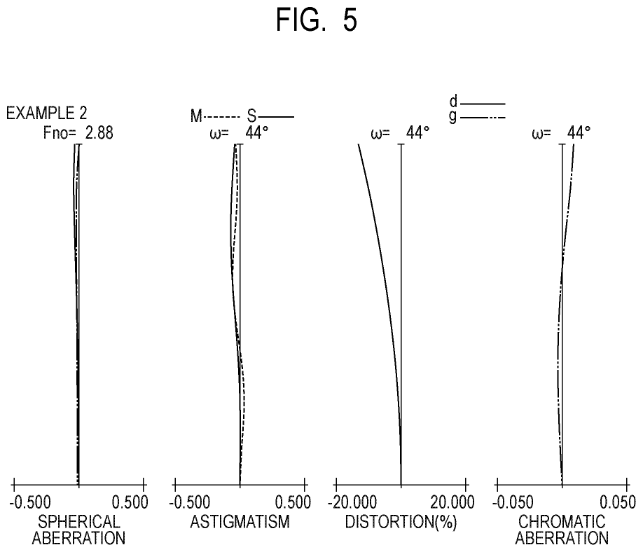

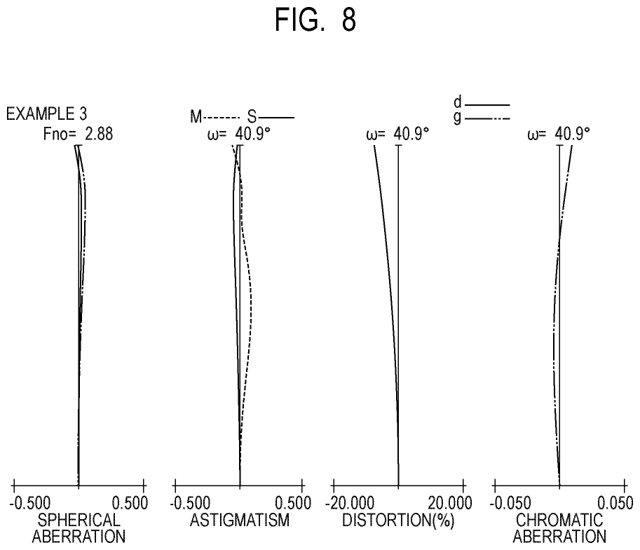

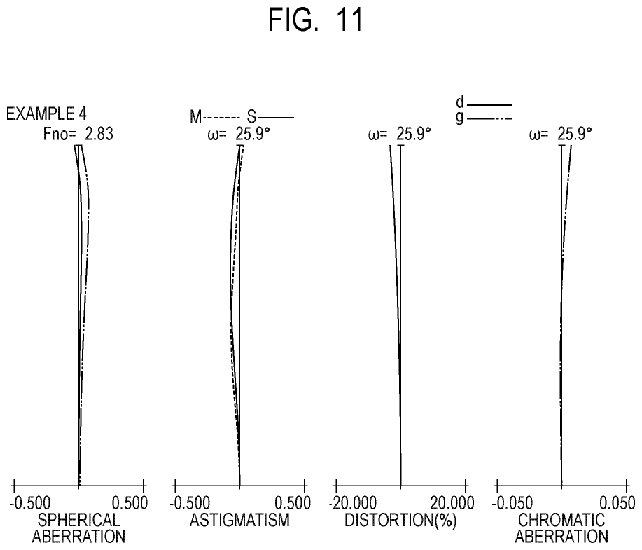

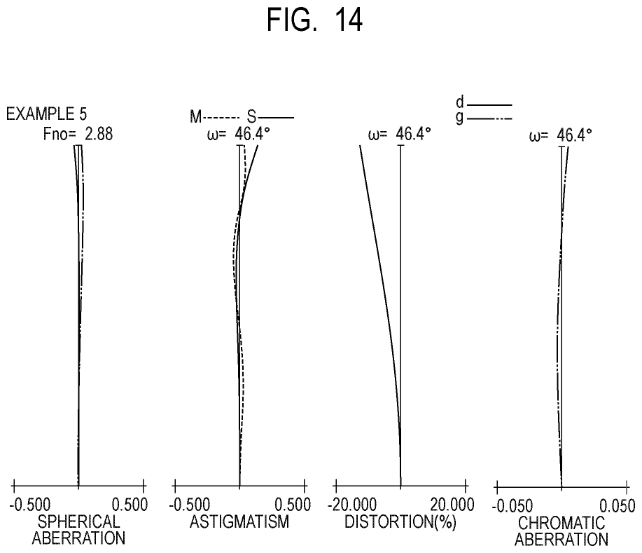

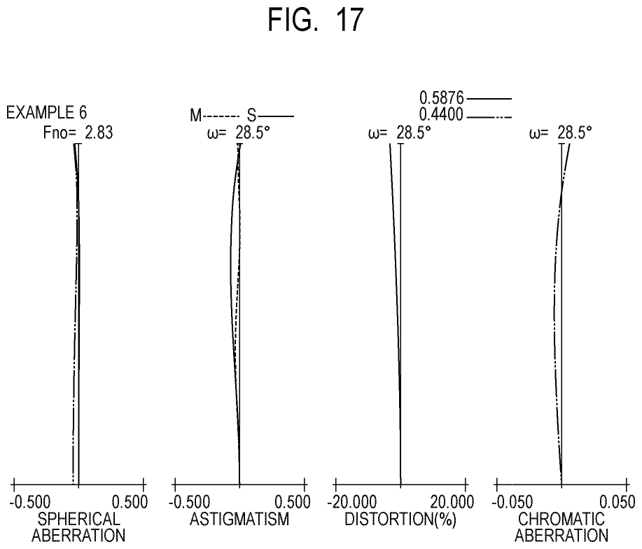

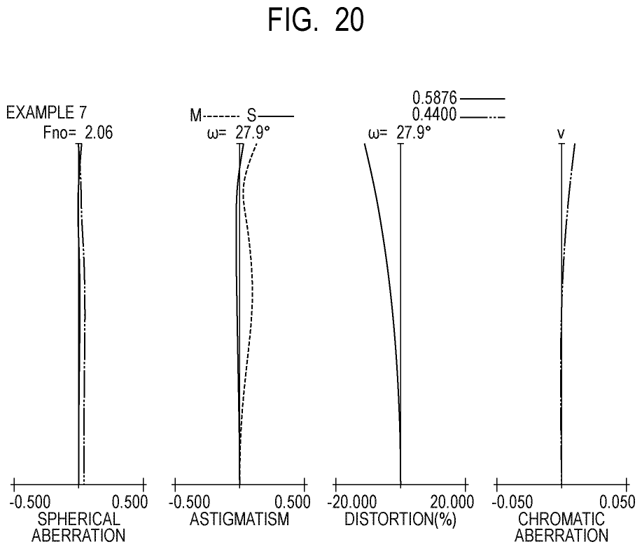

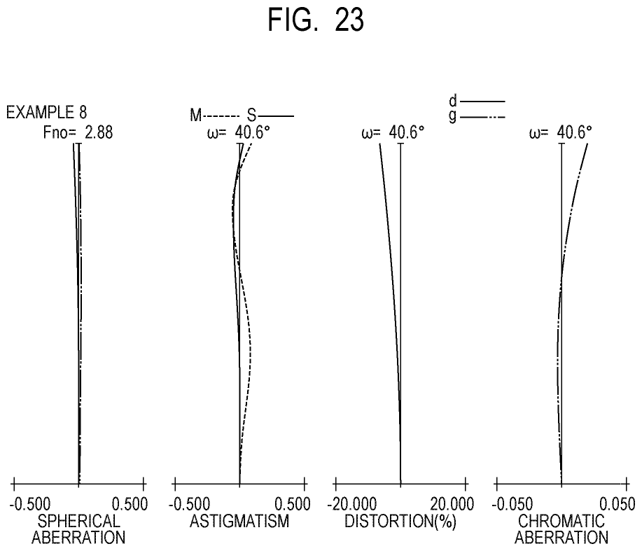

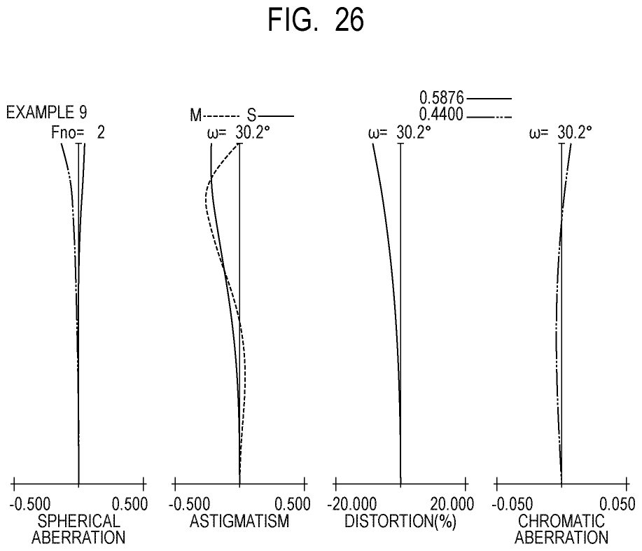

FIGS. 2, 5, 8, 11, 14, 17, 20, 23 and 26 show longitudinal aberration diagrams of the optical systems L0 according to Examples 1 to 9 during focusing on infinity, respectively.

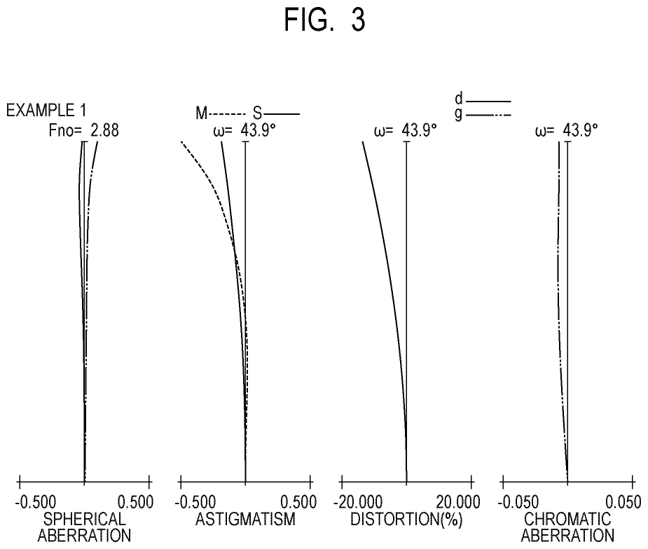

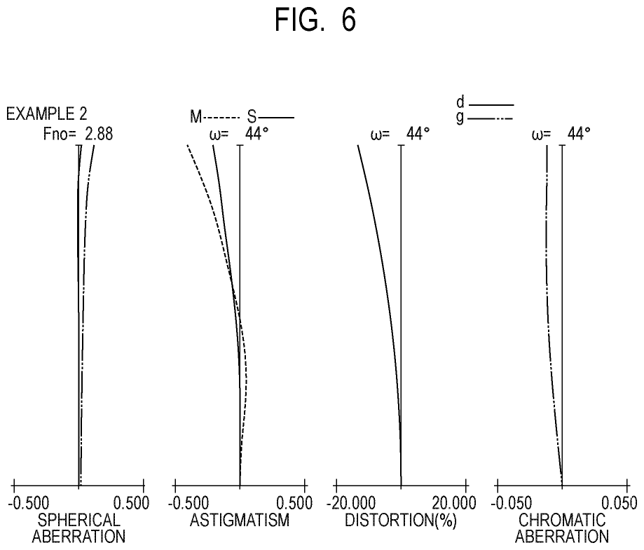

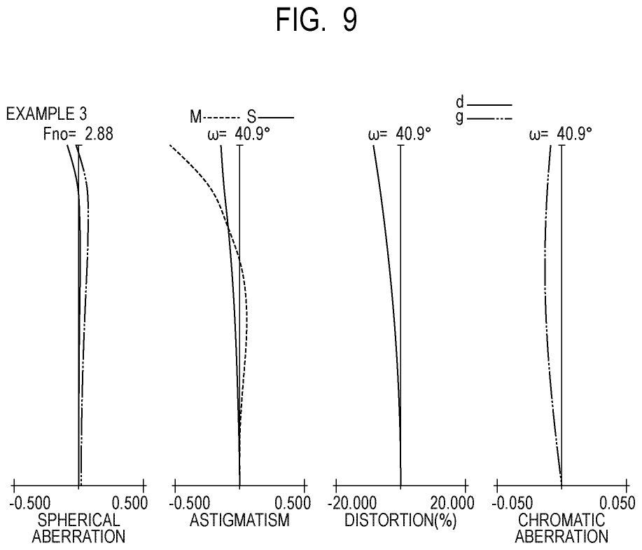

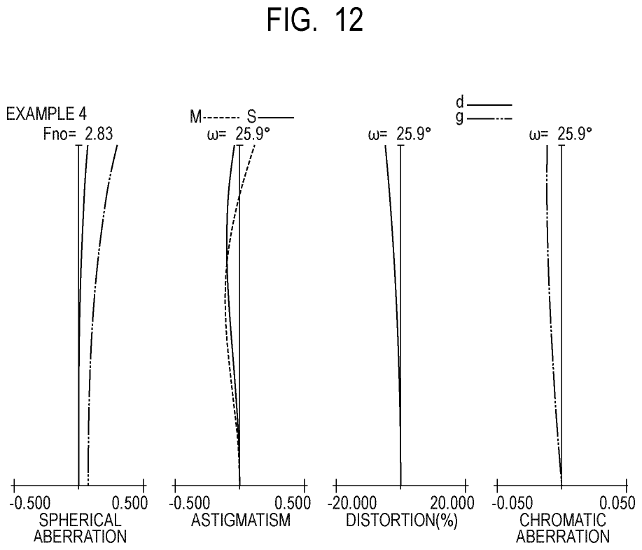

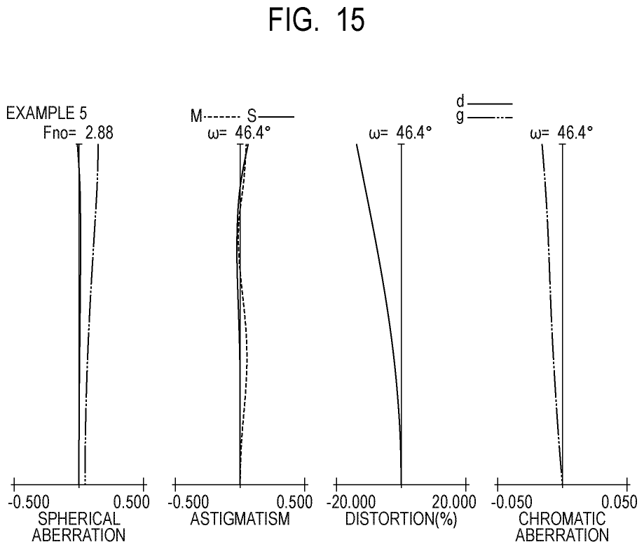

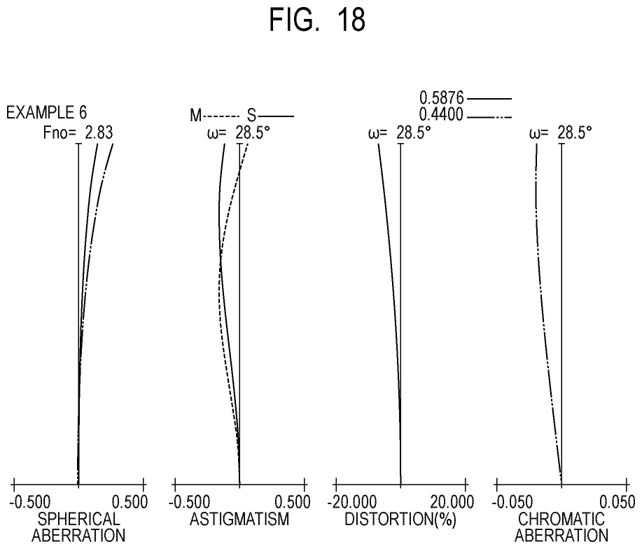

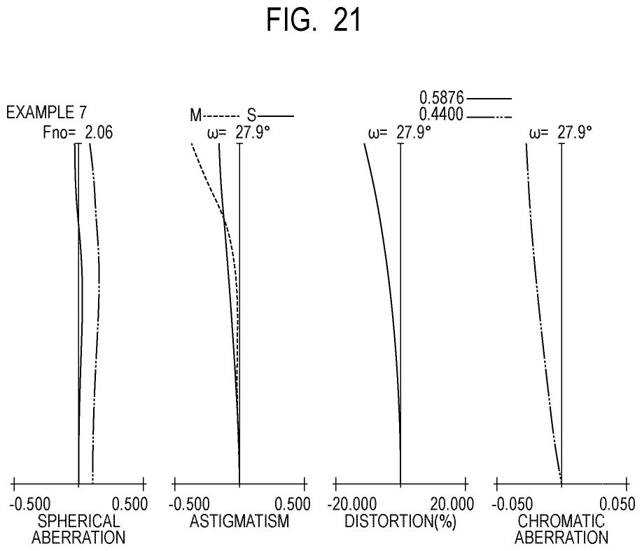

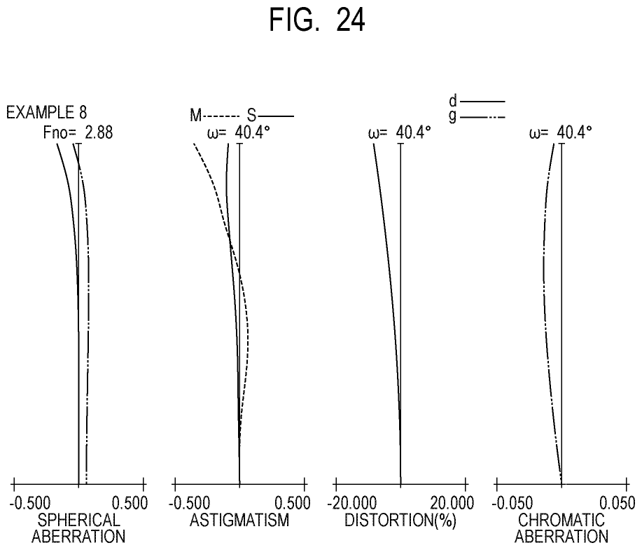

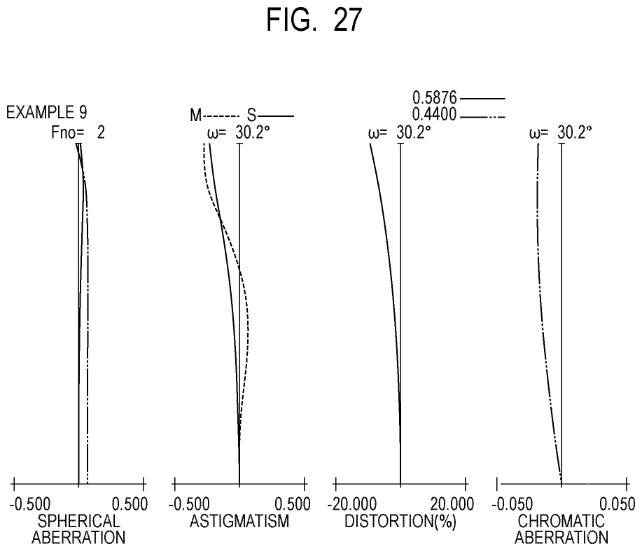

Further, FIGS. 3, 6, 9, 12, 15, 18, 21, 24 and 27 show longitudinal aberration diagrams of the optical systems L0 according to Examples 1 to 9 during focusing on the closest distance, respectively.

In a spherical aberration diagram, Fno represents a F-number, and amounts of spherical aberrations for the d-line (wavelength of 587.56 nm) and the g-line (wavelength of 435.835 nm) are shown.

In an astigmatism diagram, S represents a sagittal image plane, and M represents a meridional image plane.

A distortion diagram shows an amount of distortion for the d-line, and a chromatic aberration diagram shows an amount of lateral chromatic aberration for the g-line.

In each of the astigmatism diagram, the distortion diagram, and the chromatic aberration diagram, ω represents a half angle of view (degrees) by paraxial calculation.

Next, characteristic structures of the optical system L0 according to each of Examples 1 to 9 are described.

The optical system L0 according to each of Examples 1 to 9 includes, in order from the object side to the image side, a first lens unit L1 having a positive refractive power that does not move (is stationary) during focusing, and a second lens unit L2 having a positive refractive power that moves on an optical axis during the focusing.

In the optical system L0 according to each of Examples 1 to 9, a light flux diameter of a light flux incident on the second lens unit L2 is reduced by appropriately setting a lens configuration such that each of the first lens unit L1 and the second lens unit L2 has a positive refractive power. This makes it possible to reduce a size and weight of the focusing unit.

In addition, in the optical system L0 according to each of Examples 1 to 9, it is possible to achieve both of suppression of a variation in angle of view which occurs during focusing and a weight reduction since only the second lens unit L2 moves during the focusing.

Further, the number (total number) of lenses included in the optical system L0 according to each of Examples 1 to 9 is nine or less. Here, each lens included in a cemented lens is counted as one lens. Further, replica resin layer (referred to as a replica aspherical surface) provided in a complex optical element is counted as one lens.

Furthermore, in the optical system L0 according to each of Examples 1 to 9, a lens (negative lens) having a negative refractive power is arranged closest to the object side in the first lens unit L1.

In addition, the following Inequalities (1), (2) and (3) are satisfied in the optical system L0 according to each of Examples 1 to 9:

1.45<Nave2<1.67 (1)

−0.80<f2/f2lp<0.60 (2)

2.20<TD/f<5.50 (3).

In Inequality (1), Nave2 represents an average value of refractive indices of all lenses included in the second lens unit L2 with respect to the d-line.

In Inequality (2), f2 represents a focal length of the second lens unit L2, and f2lp represents a focal length of a lens Gb2lp (first lens) having the largest absolute value of the focal length among the all lenses included in the second lens unit L2.

In Inequality (3), TD represents a total optical length of the optical system L0, and f represents a focal length of the entire optical system L0.

Here, the total optical length of the optical system L0 is a distance on the optical axis between a lens surface closest to the object side in the optical system L0, namely a lens surface on the object side in a lens arranged closest to the object side in the optical system L0, and the image plane IP.

Inequality (1) is an inequality for the average value of the refractive indices of at least one lens included in the second lens unit L2.

In order to reduce a weight of the focusing unit, it is necessary to select a glass material having a small specific gravity, a low refractive index, and a sufficient optical performance for at least one lens included in the focusing unit.

If a ratio of lenses formed by a material having a high refractive index among at least one lens included in the second lens unit L2 increases such that the value exceeds the upper limit value in Inequality (1), a ratio of lenses having a large specific gravity increases, so that it becomes difficult to reduce the weight of the focusing unit.

On the other hand, when a ratio of lenses formed by a material having a low refractive index among at least one lens included in the second lens unit L2 increases such that the value falls below the lower limit value in Inequality (1), selectable materials are limited, so that it becomes difficult to obtain a sufficient optical performance.

Inequality (2) is an inequality for the focal length f2lp of the lens Gb2lp having the largest absolute value of the focal length among at least one lens included in the second lens unit L2, which is normalized by the focal length f2 of the second lens unit L2.

Specifically, Inequality (2) defines a power of the lens suitable for reducing the weight of the focusing unit and reducing the field curvature.

If an absolute value of the focal length of each lens included in the second lens unit L2 becomes small such that the ratio exceeds the upper limit value or falls below the lower limit value in Inequality (2), it becomes difficult to achieve both of a reduction in field curvature and a reduction in lateral chromatic aberration.

Inequality (3) is an inequality for the total optical length TD normalized by the focal length f of the entire optical system L0, namely defines ranges of the focal length f and the total optical length TD in the entire optical system L0.

If the ratio exceeds the upper limit value in Inequality (3), the total optical length TD becomes long, so that it becomes difficult to achieve a sufficient weight reduction.

On the other hand, if the ratio falls below the lower limit value in Inequality (3), the total optical length TD becomes short, so that a sufficient weight reduction can be achieved, but it becomes difficult to obtain a sufficient optical performance.

In the optical system L0 according to each of Examples 1 to 9, it is preferred that the following Inequalities (1a), (2a) and (3a) be satisfied instead of Inequalities (1) to (3):

1.47<Nave2<1.66 (1a)

−0.70<f2/f2lp<0.59 (2a)

2.23<TD/f<5.48 (3a).

Further, in the optical system L0 according to each of Examples 1 to 9, it is more preferred that the following Inequalities (1b), (2b) and (3b) be satisfied instead of Inequalities (1a) to (3a):

1.50<Nave2<1.65 (1b)

−0.60<f2/f2lp<0.58 (2b)

2.26<TD/f<5.46 (3b).

In addition, in the optical system L0 according to each of Examples 1 to 9, it is preferred that at least one of the following Inequalities (4), (5), (6), (7), (8), (9), (10), (11), (12), (13) and (14) be satisfied:

0.60<SPD/TD<0.80 (4)

1.50<f2/f<3.00 (5)

0.20<f1r/f1<1.10 (6)

0.50<f1/f2<2.00 (7)

−3.00<(Rn2+Rn1)/(Rn2−Rn1)<0.01 (8)

1.40<f1/f<3.70 (9)

0.05<DF/TD<0.18 (10)

0.15<SK/TD<0.46 (11)

0.10<Db1/TD<0.24 (12)

0.10<Db2/TD<0.26 (13)

0.80<d<3.10 (14).

In Inequality (4), SPD represents a distance on the optical axis between the aperture stop SP and the image plane IP.

In Inequality (6), f1r represents a focal length of a lens arranged closest to the image side in the first lens unit L1, and f1 represents a focal length of the first lens unit L1.

In Inequality (8), Rn1 and Rn2 represent curvature radii of a lens surface on the object side and that on the image side in a lens having a negative refractive power arranged closest to the object side in the first lens unit L1, respectively.

In Inequality (10), DF represents a distance on the optical axis between a lens surface on the object side in the second lens unit L2, and a lens surface on the image side in a lens arranged adjacent to the second lens unit L2 on the object side of the second lens unit L2 or the aperture stop SP when focusing on infinity.

In other words, the lens surface on the object side in the second lens unit L2 is a lens surface on the object side in a lens (second lens) arranged closest to the object side in the second lens unit L2.

Further, the lens adjacent to the second lens unit L2 on the object side of the second lens unit L2 is a lens arranged adjacent to the object side of the lens arranged closest to the object side in the second lens unit L2.

In Inequality (11), SK represents an air-equivalent distance on the optical axis between a lens surface on the image side in a lens arranged closest to the image side in the optical system L0, and the image plane IP.

In Inequality (12), Db1 represents a sum of lens thicknesses on the optical axis between a lens surface closest to the object side and that closest to the image side in the first lens unit L1, namely the sum of the lens thicknesses on the optical axis of lenses included in the first lens unit L1.

In Inequality (13), Db2 represents a sum of lens thicknesses on the optical axis between a lens surface closest to the object side and that closest to the image side in the second lens unit L2, namely the sum of the lens thicknesses on the optical axis of lenses included in the second lens unit L2.

In Inequality (14), d represents a specific gravity of a lens having the largest absolute value of the focal length among at least one lens included in the second lens unit L2.

Inequality (4) is an inequality for the distance SPD between the aperture stop SP and the image plane IP, which is normalized by the total optical length TD of the optical system L0, and specifically defines a position of the aperture stop SP.

If the aperture stop SP is arranged on the object side such that the ratio exceeds the upper limit value in Inequality (4), the number of lenses that can be arranged on the object side of the aperture stop SP decreases, so that it becomes difficult to reduce a spherical aberration and an axial chromatic aberration.

On the other hand, if the ratio falls below the lower limit value in Inequality (4), the aperture stop SP is arranged close to the image plane IP, so that an incident angle with respect to the image plane IP increases in the vicinity of the maximum image height, which causes color shading.

Inequality (5) is an inequality for the focal length f2 of the second lens unit L2 normalized by the focal length f of the optical system L0, and specifically defines a condition under which the closest distance at which focusing can be performed can be shortened with suppressing a change in optical performance during focusing.

If the positive focal length f2 of the second lens unit L2 becomes large such that the ratio exceeds the upper limit value in Inequality (5), a focus position sensitivity of the second lens unit L2 (a ratio of a moving amount of the image plane IP to that of the focusing unit) becomes too small. Therefore, it becomes difficult to shorten the closest distance at which focusing can be performed, or it becomes difficult to shorten a total length of the optical system L0 in order to secure an air interval in which focusing can be performed.

On the other hand, if the positive focal length f2 of the second lens unit L2 becomes small such that the ratio falls below the lower limit value in Inequality (5), a refractive power of the second lens unit L2 becomes too large, so that a change in optical performance such as a spherical aberration, a field curvature, and a change in angle of view during focusing becomes too large.

Inequality (6) is an inequality for the focal length f1r of a lens arranged closest to the image side in the first lens unit L1, which is normalized by the focal length f1 of the first lens unit L1.

If the ratio exceeds the upper limit value in Inequality (6), a light flux diameter of a light flux incident on the second lens unit L2 becomes large to increase a lens diameter on the object side of the focusing unit, so that a weight thereof increases.

On the other hand, if the ratio falls below the lower limit value in Inequality (6), a refractive power of the first lens unit L1 increases, so that a spherical aberration and an axial chromatic aberration increase.

Inequality (7) is an inequality for defining a relationship between the focal length f1 of the first lens unit L1 and the focal length f2 of the second lens unit L2.

If the focal length f2 of the second lens unit L2 becomes small such that the ratio exceeds the upper limit value in Inequality (7), a refractive power of the second lens unit L2 becomes too large, so that a change in optical performance such as a spherical aberration, a field curvature, and a change in angle of view during focusing become too large.

Further, if the focal length f1 of the first lens unit L1 becomes large such that the ratio exceeds the upper limit value in Inequality (7), a total length of the optical system L0 increases.

On the other hand, if the focal length f2 of the second lens unit L2 becomes large such that the ratio falls below the lower limit value in Inequality (7), the refractive power of the second lens unit L2 becomes too small, so that a moving amount thereof during focusing increases, with the result that the total length of the optical system L0 increases.

Further, if the focal length f1 of the first lens unit L1 becomes small such that the ratio falls below the lower limit value in Inequality (7), it becomes difficult to correct a spherical aberration and an axial chromatic aberration.

Inequality (8) is an inequality for defining a range of a shape factor of a lens having a negative refractive power arranged closest to the object side in the optical system L0.

If the ratio exceeds the upper limit value in Inequality (8), a curvature radius of a lens surface on the object side becomes small with respect to that of a lens surface on the image side in the lens, so that a field curvature increases.

On the other hand, if the ratio falls below the lower limit value in Inequality (8), it becomes advantageous to reduce a field curvature, but a lens diameter of the lens becomes large, resulting in an increase in size.

Inequality (9) is an inequality for the focal length f1 of the first lens unit L1 normalized by the focal length f of the optical system L0.

If the ratio exceeds the upper limit value in Inequality (9), a refractive power of the first lens unit L1 becomes small, so that a total length of the optical system L0 increases.

On the other hand, if the ratio falls below the lower limit value in Inequality (9), it becomes advantageous for downsizing of the focusing unit, but a spherical aberration and an axial chromatic aberration increase.

Inequality (10) is an inequality of the distance DF between a lens surface on the object side in the second lens unit L2, and a lens surface on the image side in a lens adjacent to the second lens unit L2 on the object side of the second lens unit L2 or the aperture stop SP when focusing on infinity, which is normalized by the total optical length TD of the optical system L0.

If the ratio exceeds the upper limit value in Inequality (10), the total optical length TD increases in order to suppress deterioration in optical performance, resulting in an increase in size of the optical system L0.

On the other hand, if the ratio falls below the lower limit value in Inequality (10), it becomes difficult to achieve both of size reduction and suppression of deterioration in optical performance for focusing.

Inequality (11) is an inequality for the air-equivalent distance SK between a lens surface closest to the image side in the optical system L0 and the image plane IP, which is normalized by the total optical length TD of the optical system L0.

If the ratio exceeds the upper limit value in Inequality (11), intervals between respective lenses in the optical system L0 become small, so that it becomes difficult to reduce a spherical aberration and a lateral chromatic aberration.

On the other hand, if the ratio falls below the lower limit value in Inequality (11), the air-equivalent distance SK between the lens surface closest to the image side in the optical system L0 and the image plane IP becomes small, so that a spherical aberration and a coma increase.

Inequality (12) is an inequality for the sum Db1 of thicknesses of lenses included in the first lens unit L1, which is normalized by the total optical length TD of the optical system L0.

If the ratio exceeds the upper limit value in Inequality (12), the thickness of each lens included in the first lens unit L1 increases, so that it becomes difficult to reduce a weight thereof.

On the other hand, if the ratio falls below the lower limit value in Inequality (12), it becomes difficult to reduce an axial chromatic aberration.

Inequality (13) is an inequality for the sum Db2 of thicknesses of lenses included in the second lens unit L2, which is normalized by the total optical length TD of the optical system L0.

If the ratio exceeds the upper limit value in Inequality (13), the thickness of each lens included in the second lens unit L2 increases to increase a size of the focusing unit, so that it becomes difficult to reduce the size thereof.

On the other hand, if the ratio falls below the lower limit value in Inequality (13), it becomes difficult to reduce a lateral chromatic aberration.

Inequality (14) is an inequality for a specific gravity d of a lens having the largest absolute value of the focal length among at least one lens included in the second lens unit L2.

If the value exceeds the upper limit value in Inequality (14), a weight of the focusing unit increases.

On the other hand, if the value falls below the lower limit value in Inequality (14), it becomes difficult to form a lens having a refractive power suitable for focusing.

In the optical system L0 according to each of Examples 1 to 9, it is more preferred that the following Inequalities (4a), (5a), (6a), (7a), (8a), (9a), (10a), (11a), (12a), (13a) and (14a) be satisfied instead of Inequalities (4) to (14):

0.61<SPD/TD<0.79 (4a)

1.53<f2/f<2.98 (5a)

0.25<f1r/f1<1.07 (6a)

0.55<f1/f2<1.80 (7a)

−2.95<(Rn2+Rn1)/(Rn2−Rn1)<−0.03 (8a)

1.45<f1/f<3.65 (9a)

0.06<DF/TD<0.17 (10a)

0.16<SK/TD<0.45 (11a)

0.11<Db1/TD<0.22 (12a)

0.11<Db2/TD<0.24 (13a)

0.90<d<3.08 (14a).

Further, in the optical system L0 according to each of Examples 1 to 9, it is still more preferred that the following Inequalities (4b), (5b), (6b), (7b), (8b), (9b), (10b), (11b), (12b), (13b) and (14b) be satisfied instead of Inequalities (4a) to (14a):

0.62<SPD/TD<0.78 (4b)

1.56<f2/f<2.96 (5b)

0.30<f1r/f1<1.04 (6b)

0.60<f1/f2<1.60 (7b)

−2.90<(Rn2+Rn1)/(Rn2−Rn1)<−0.05 (8b)

1.50<f1/f<3.60 (9b)

0.07<DF/TD<0.16 (10b)

0.17<SK/TD<0.44 (11b)

0.12<Db1/TD<0.20 (12b)

0.12<Db2/TD<0.22 (13b)

1.00<d<3.06 (14b).

In the optical system L0 according to each of Examples 1 to 9, it is preferred that the second lens unit L2 consists of four or less lenses.

Thereby, it is possible to easily achieve both of weight reduction of the focusing unit and optical performance.

It is preferred that the optical system L0 according to each of Examples 1 to 9 consists of six or more lenses.

Thereby, it is possible to easily achieve both of weight reduction of the optical system L0 and an optical performance.

In the optical system L0 according to each of Examples 1 to 9, it is preferred that the lens having the largest absolute value of the focal length among at least one lens included in the second lens unit L2 be arranged closest to the image side in the second lens unit L2.

Thereby, it is possible to easily suppress a change in distortion during focusing.

In the optical system L0 according to each of Examples 1 to 9, it is preferred that the lens having the largest absolute value of the focal length among at least one lens included in the second lens unit L2 be an aspherical lens.

Next, a detailed structure of the optical system L0 according to each of Examples 1 to 9 is described.

FIG. 1 shows a schematic cross sectional view of the optical system L0 according to Example 1 when focusing on infinity.

In the optical system L0 according to Example 1, the first lens unit L1 arranged closest to the object side and the second lens unit L2 arranged adjacent to the first lens unit L1 are provided.

The first lens unit L1 consists of, in order from the object side to the image side, a meniscus lens that is convex toward the object side and has a negative refractive power, a meniscus lens that is convex toward the object side and has a negative refractive power, a biconvex lens that has a positive refractive power, and a meniscus lens that is concave toward the object side and has a positive refractive power.

The second lens unit L2 consists of, in order from the object side to the image side, a meniscus lens that is concave toward the object side and has a positive refractive power, a meniscus lens that is cemented to the meniscus lens, is concave toward the object side, and has a negative refractive power, a biconvex lens that has a positive refractive power, and a lens having a positive refractive power, in which a lens surface on the object side is concave toward the object side and a lens surface on the image side is convex toward the image side in the vicinity of the optical axis.

In the optical system L0 according to Example 1, the lens Gb2lp having the largest absolute value of the focal length among at least one lens included in the second lens unit L2 is arranged closest to the image side in the second lens unit L2. Further, the focusing unit is the second lens unit L2.

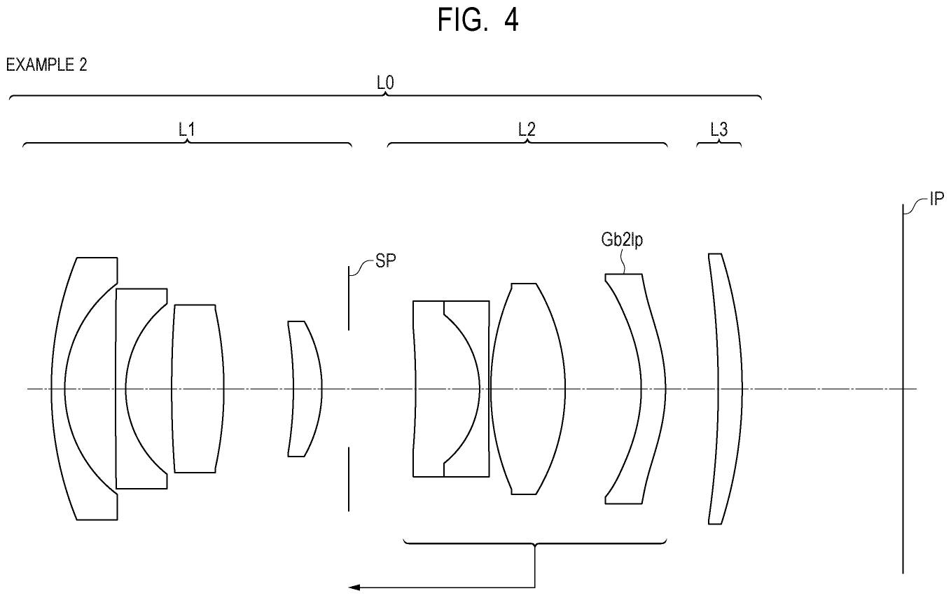

FIG. 4 shows a schematic cross sectional view of the optical system L0 according to Example 2 when focusing on infinity.

In the optical system L0 according to Example 2, the first lens unit L1 arranged closest to the object side, the second lens unit L2 arranged adjacent to the first lens unit L1, and the third lens unit L3 arranged closest to the image side are provided.

The first lens unit L1 consists of, in order from the object side to the image side, a meniscus lens that is convex toward the object side and has a negative refractive power, a meniscus lens that is convex toward the object side and has a negative refractive power, a biconvex lens that has a positive refractive power, and a meniscus lens that is concave toward the object side and has a positive refractive power.

The second lens unit L2 consists of, in order from the object side to the image side, a meniscus lens that is concave toward the object side and has a positive refractive power, a biconcave lens that is cemented to the meniscus lens and has a negative refractive power, a biconvex lens having a positive refractive power, and a lens having a negative refractive power, in which a lens surface on the object side is concave toward the object side and a lens surface on the image side is convex toward the image side in the vicinity of the optical axis.

The third lens unit L3 consists of a meniscus lens that is concave toward the object side and has a positive refractive power.

In the optical system L0 according to Example 2, the lens Gb2lp having the largest absolute value of the focal length among at least one lens included in the second lens unit L2 is arranged closest to the image side in the second lens unit L2. Further, the focusing unit is the second lens unit L2.

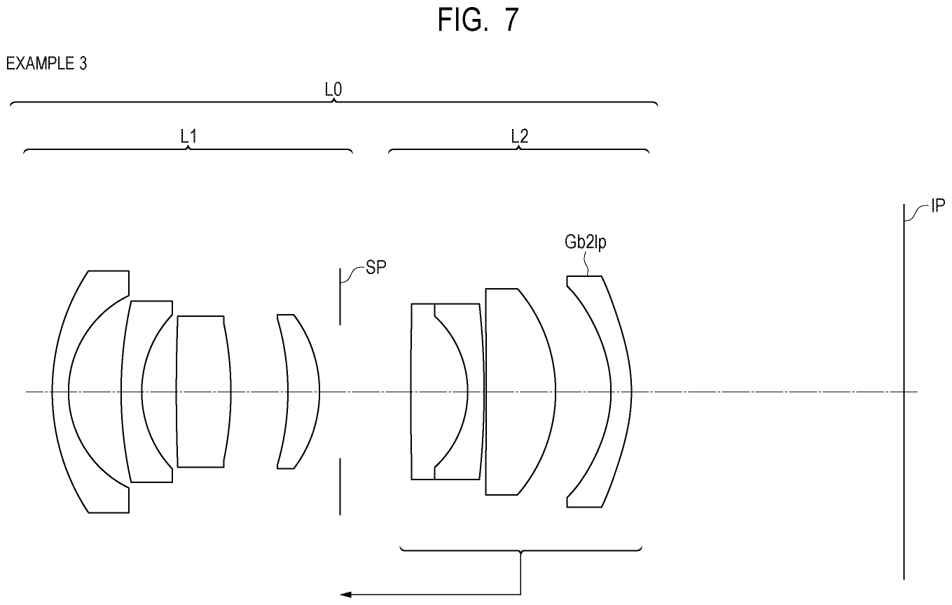

FIG. 7 shows a schematic cross sectional view of the optical system L0 according to Example 3 when focusing on infinity.

In the optical system L0 according to Example 3, the first lens unit L1 arranged closest to the object side and the second lens unit L2 arranged adjacent to the first lens unit L1 are provided.

The first lens unit L1 consists of, in order from the object side to the image side, a meniscus lens that is convex toward the object side and has a negative refractive power, a meniscus lens that is convex toward the object side and has a negative refractive power, a biconvex lens having a positive refractive power, and a meniscus lens that is concave toward the object side and has a positive refractive power.

The second lens unit L2 consists of, in order from the object side to the image side, a biconvex lens having a positive refractive power, a meniscus lens which is cemented to the lens, is concave toward the object side, and has a negative refractive power, a meniscus lens that is concave toward the object side and has a positive refractive power, and a lens having a negative refractive power, in which a lens surface on the object side is concave toward the object side and a lens surface on the image side is convex toward the image side in the vicinity of the optical axis.

In the optical system L0 according to Example 3, the lens Gb2lp having the largest absolute value of the focal length among at least one lens included in the second lens unit L2 is arranged closest to the image side in the second lens unit L2. Further, the focusing unit is the second lens unit L2.

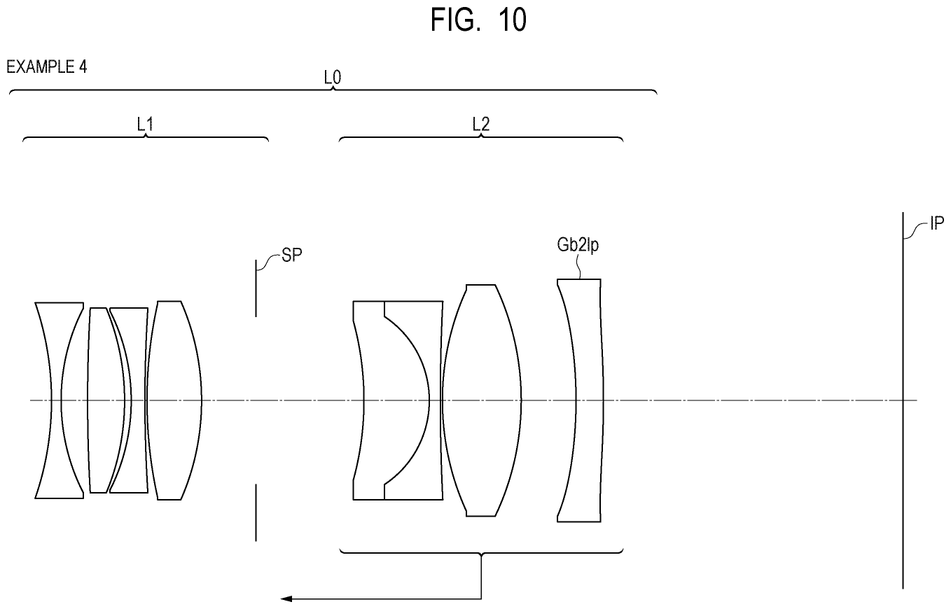

FIG. 10 shows a schematic cross sectional view of an optical system L0 according to Example 4 when focusing on infinity.

In the optical system L0 according to Example 4, the first lens unit L1 arranged closest to the object side and the second lens unit L2 arranged adjacent to the first lens unit L1 are provided.

The first lens unit L1 consists of, in order from the object side to the image side, a biconcave lens having a negative refractive power, a biconvex lens having a positive refractive power, a biconcave lens having a negative refractive power, and a biconvex lens having a positive refractive power.

The second lens unit L2 consists of, in order from the object side to the image side, a meniscus lens that is concave toward the object side and has a positive refractive power, a biconcave lens that is cemented to the meniscus lens and has a negative refractive power, a biconvex lens having a positive refractive power, and a lens having a negative refractive power, in which a lens surface on the object side is concave toward the object side and a lens surface on the image side is convex toward the image side in the vicinity of the optical axis.

In the optical system L0 according to Example 4, the lens Gb2lp having the largest absolute value of the focal length among at least one lens included in the second lens unit L2 is arranged closest to the image side in the second lens unit L2. Further, the focusing unit is the second lens unit L2.

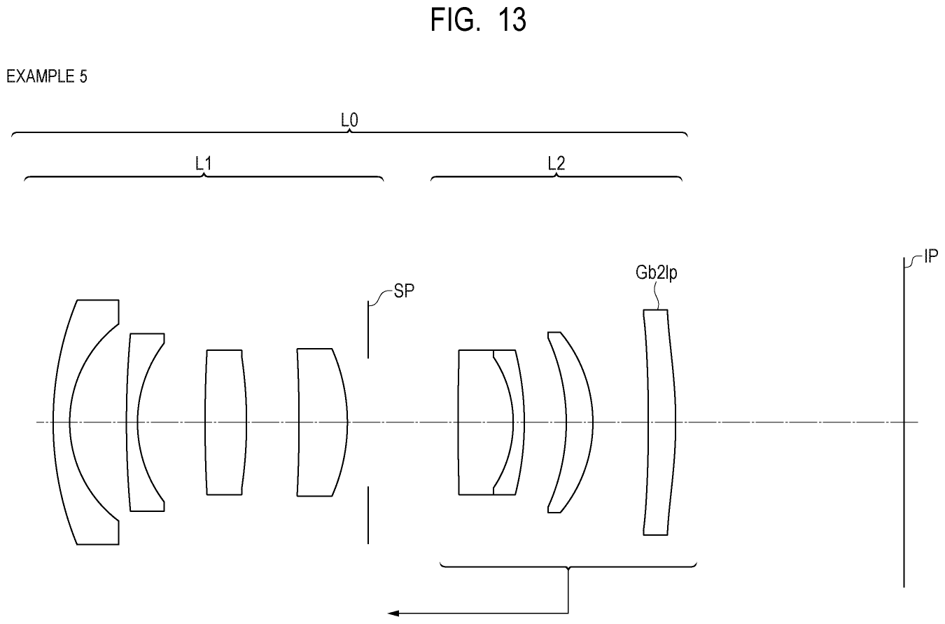

FIG. 13 shows a schematic cross sectional view of the optical system L0 according to Example 5 when focusing on infinity.

In the optical system L0 according to Example 5, the first lens unit L1 arranged closest to the object side and the second lens unit L2 arranged adjacent to the first lens unit L1 are provided.

The first lens unit L1 consists of, in order from the object side to the image side, a meniscus lens that is convex toward the object side and has a negative refractive power, a meniscus lens that is convex toward the object side and has a negative refractive power, a biconvex lens having a positive refractive power, and a meniscus lens that is concave toward the object side and has a positive refractive power.

The second lens unit L2 consists of, in order from the object side to the image side, a biconvex lens having a positive refractive power, and a meniscus lens which is cemented to the lens, is concave toward the object side, and has a negative refractive power, a meniscus lens that is concave toward the object side and has a positive refractive power, and a lens having a positive refractive power, in which a lens surface on the object side is concave toward the object side and a lens surface on the image side is convex toward the image side in the vicinity of the optical axis.

In the optical system L0 according to Example 5, the lens Gb2lp having the largest absolute value of the focal length among at least one lens included in the second lens unit L2 is arranged closest to the image side in the second lens unit L2. Further, the focusing unit is the second lens unit L2.

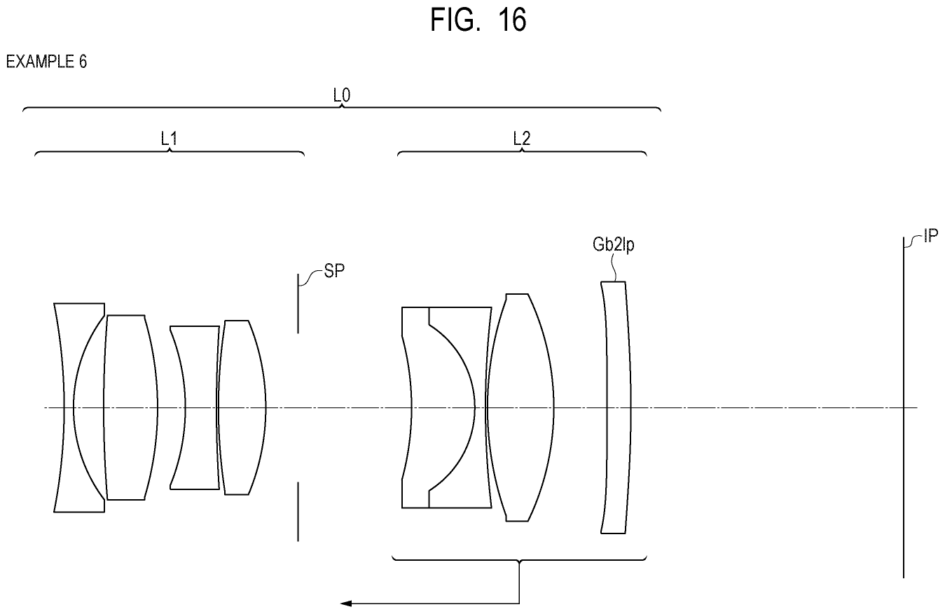

FIG. 16 shows a schematic cross sectional view of the optical system L0 according to Example 6 when focusing on infinity.

In the optical system L0 according to Example 6, the first lens unit L1 arranged closest to the object side and the second lens unit L2 arranged adjacent to the first lens unit L1 are provided.

The first lens unit L1 consists of, in order from the object side to the image side, a biconcave lens having a negative refractive power, a biconvex lens having a positive refractive power, a biconcave lens having a negative refractive power, and a biconvex lens having a positive refractive power.

The second lens unit L2 consists of, in order from the object side to the image side, a meniscus lens that is concave toward the object side and has a positive refractive power, a biconcave lens that is cemented to the meniscus lens and has a negative refractive power, a biconvex lens having a positive refractive power, and a lens having a positive refractive power, in which a lens surface on the object side is concave toward the object side and a lens surface on the image side is convex toward the image side in the vicinity of the optical axis.

In the optical system L0 according to Example 6, the lens Gb2lp having the largest absolute value of the focal length among at least one lens included in the second lens unit L2 is arranged closest to the image side in the second lens unit L2. Further, the focusing unit is the second lens unit L2.

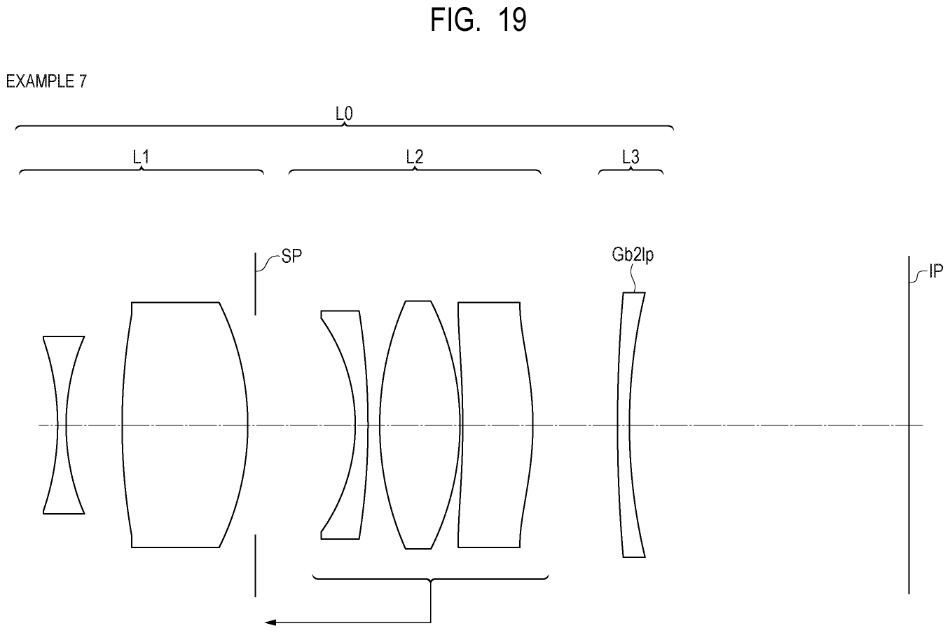

FIG. 19 shows a schematic cross sectional view of the optical system L0 according to Example 7 when focusing on infinity.

In the optical system L0 according to Example 7, the first lens unit L1 arranged closest to the object side, the second lens unit L2 arranged adjacent to the first lens unit L1, and the third lens unit L3 arranged closest to the image side are provided.

The first lens unit L1 consists of, in order from the object side to the image side, a biconcave lens having a negative refractive power and a biconvex lens having a positive refractive power.

The second lens unit L2 consists of, in order from the object side to the image side, a meniscus lens which is concave toward the object side and has a negative refractive power, a biconvex lens having a positive refractive power, and a meniscus lens which is concave toward the object side in the vicinity of the optical axis and has a positive refractive power.

The third lens unit L3 consists of a meniscus lens which is convex toward the object side and has a negative refractive power.

In the optical system L0 according to Example 7, the lens Gb2lp having the largest absolute value of the focal length among at least one lens included in the second lens unit L2 is arranged closest to the image side in the second lens unit L2. Further, the focusing unit is the second lens unit L2.

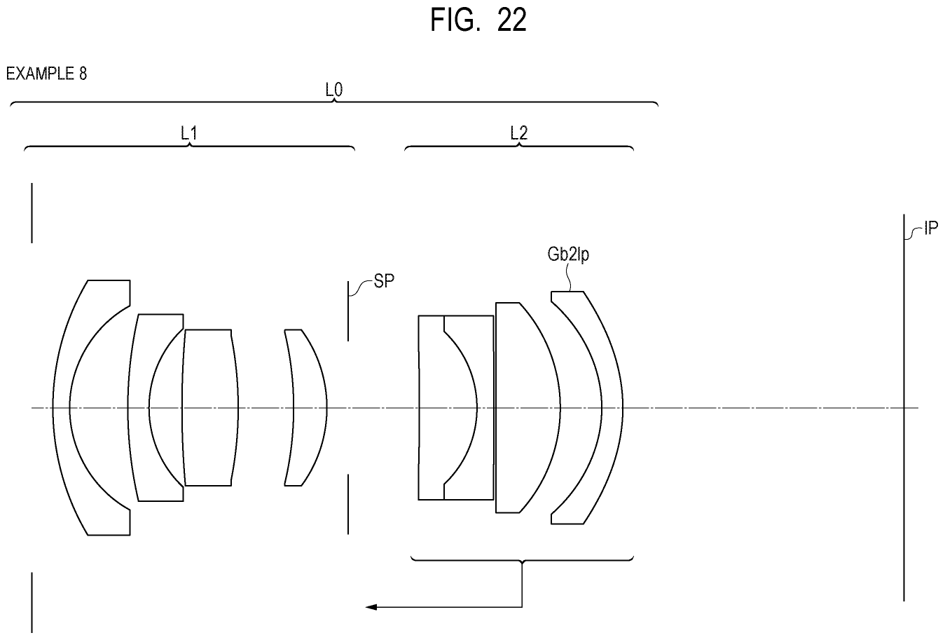

FIG. 22 shows a schematic cross sectional view of the optical system L0 according to Example 8 when focusing on infinity.

In the optical system L0 according to Example 8, the first lens unit L1 arranged closest to the object side and the second lens unit L2 arranged adjacent to the first lens unit L1 are provided.

The first lens unit L1 consists of, in order from the object side to the image side, a meniscus lens that is convex toward the object side and has a negative refractive power, a meniscus lens that is convex toward the object side and has a negative refractive power, a biconvex lens having a positive refractive power, and a meniscus lens that is concave toward the object side and has a positive refractive power.

The second lens unit L2 consists of, in order from the object side to the image side, a meniscus lens which is convex toward the object side and has a positive refractive power, a meniscus lens which is cemented to the meniscus lens, is concave toward the object side, and has a negative refractive power, a meniscus lens that is concave toward the object side and has a positive refractive power, and a lens having a negative refractive power, in which a lens surface on the object side is concave toward the object side and a lens surface on the image side is convex toward the image side in the vicinity of the optical axis.

In the optical system L0 according to Example 8, the lens Gb2lp having the largest absolute value of the focal length among at least one lens included in the second lens unit L2 is arranged closest to the image side in the second lens unit L2. Further, the focusing unit is the second lens unit L2.

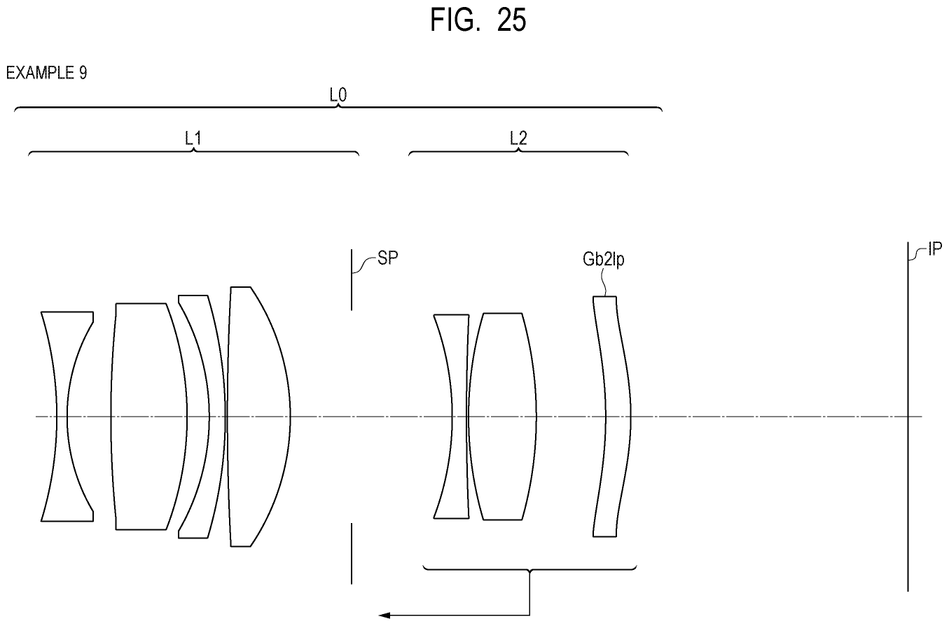

FIG. 25 shows a schematic cross sectional view of the optical system L0 according to Example 9 when focusing on infinity.

In the optical system L0 according to Example 9, the first lens unit L1 arranged closest to the object side and the second lens unit L2 arranged adjacent to the first lens unit L1 are provided.

The first lens unit L1 consists of, in order from the object side to the image side, a biconcave lens having a negative refractive power, a biconvex lens having a positive refractive power, a meniscus lens that is concave toward the object side and has a negative refractive power, and a biconvex lens having a positive refractive power.

The second lens unit L2 consists of, in order from the object side to the image side, a biconcave lens having a negative refractive power, a biconvex lens having a positive refractive power, and a lens having a positive refractive power, in which a lens surface on the object side is concave toward the object side and a lens surface on the image side is convex toward the image side in the vicinity of the optical axis.

In the optical system L0 according to Example 9, the lens Gb2lp having the largest absolute value of the focal length among at least one lens included in the second lens unit L2 is arranged closest to the image side in the second lens unit L2. Further, the focusing unit is the second lens unit L2.

Next, Numerical Examples 1 to 9 corresponding to Examples 1 to 9 are described below.

In surface data of each numerical example, when m is the number of an optical surface counted from the object side, rₘ represents a curvature radius of the m-th surface, and dₘ represents a surface interval (distance on the optical axis) between the m-th surface and the (m+1)-th surface.

Further, ndₘ represents a refractive index of an optical member between the m-th surface and the (m+1)-th surface with respect to the d-line, and vdₘ represents an Abbe number of the optical member between the m-th surface and the (m+1)-th surface.

The Abbe number vd is expressed by the following Expression (A), when refractive indices with respect to the d-line (587.56 nm), the F-line (486.13 nm), and the C-line (656.27 nm) of the Fraunhofer lines are represented by Nd, NF and NC, respectively:

vd=(Nd−1)/(NF−NC) (A).

In addition, θgF represents a partial dispersion ratio with respect to the g-line (435.84 nm) and the F-line, and specifically, is expressed by the following Expression (B) when the refraction index with respect to the g-line of the Fraunhofer line is represented by Ng:

θgF=(Ng−NF)/(NF−NC) (B).

In each numerical example, the surface interval d, the focal length, the F-number, and the half angle of view by the paraxial calculation are values when the optical system L0 focuses on an object at infinity.

The back focus BF represents a distance between the final surface and the image plane IP, and the total lens length is a value obtained by adding the back focus BF to a distance between the first surface (the lens surface closest to the object side) and the final surface (the lens surface closest to the image side).

An asterisk (*) is attached to the right side of the surface number of an optical surface having an aspherical shape.

The aspherical shape is expressed by the following Expression (C), when a shift amount from a surface vertex in a direction parallel to the optical axis is represented by X, a height from the optical axis in a direction perpendicular to the optical axis is represented by h, a paraxial curvature radius is represented by R, a conic constant is represented by K, and aspherical coefficients are represented by A4, A6, A8, A10 and A12:

$$X = \frac{\frac{{h}^{2}}{R}}{1 + \sqrt{1 - ( 1 + K ) {( \frac{h}{R} )}^{2}}} + {\sum }_{i = 4 , 6 , 8 , 10 , 12} Ai \times {h}^{i} . \qquad ( C )$$

“e-X” in the aspherical coefficients means “×10^{-X}”.

Values corresponding to the Inequalities (1) to (14) in the optical system L0 according to each of Numerical Examples 1 to 9 are shown in Tables 1-1 and 1-2 described later.

[Numerical example 1]
Units: mm
Surface data

| Surface | | | | |
|---|---|---|---|---|
| number | rₘ | dₘ | ndₘ | νdₘ |
| 1 | 31.779 | 1.00 | 1.61800 | 63.4 |
| 2 | 8.912 | 3.60 | | |
| 3 | 49.545 | 0.75 | 1.49700 | 81.7 |
| 4 | 8.865 | 3.66 | | |
| 5 | 89.819 | 4.49 | 1.80400 | 46.6 |
| 6 | −25.757 | 4.87 | | |
| 7 | −24.458 | 1.95 | 1.48749 | 70.2 |
| 8 | −10.415 | 1.50 | | |
| 9 (stop) | ∞ | (variable) | | |
| 10 | −45.427 | 5.20 | 1.49700 | 81.7 |
| 11 | −6.710 | 0.68 | 1.62205 | 41.1 |
| 12 | −386.087 | 0.15 | | |
| 13 | 19.498 | 5.76 | 1.48749 | 70.2 |
| 14 | −13.523 | 3.94 | | |
| 15* | −12.585 | 1.69 | 1.53500 | 56.0 |
| 16* | −13.044 | (variable) | | |
| Image | ∞ | | | |
| plane | | | | |

Aspherical surface data

Fifteenth surface
K = 6.41863e−01, A4 = 1.44387e−05, A6 = 7.00234e−06, A8 = −1.00059e−07,
A10 = 1.03099e−09, A12 = −8.33358e−12
Sixteenth surface
K = 0.00000e+00, A4 = 1.02253e−04, A6 = 5.31173e−06, A8 = −4.42186e−08,
A10 = 2.43306e−10, A12 = −2.36589e−12

Various data

| Object distance | Infinity | Closest |
|---|---|---|
| Focal length | 12.36 | |
| F-number | 2.88 | |
| Half angle of view | 43.86 | |
| Image height | 13.66 | |
| Total lens length | 62.63 | |
| BF | 18.37 | 20.69 |
| d9 | 5.02 | 2.70 |
| d16 | 18.37 | 20.69 |

Lens unit data

| Unit | Start surface | Focal length |
|---|---|---|
| 1 | 1 | 43.55 |
| 2 | 10 | 28.67 |

[Numerical example 2]
Units: mm
Surface data

| Surface | | | | |
|---|---|---|---|---|
| number | rₘ | dₘ | ndₘ | νdₘ |
| 1 | 25.629 | 1.00 | 1.61800 | 63.4 |
| 2 | 9.737 | 3.79 | | |
| 3 | 627.519 | 0.75 | 1.49700 | 81.7 |
| 4 | 7.998 | 3.43 | | |
| 5 | 81.983 | 3.89 | 1.80400 | 46.6 |
| 6 | −27.373 | 5.18 | | |
| 7 | −28.725 | 2.13 | 1.48749 | 70.2 |
| 8 | −10.106 | 2.00 | | |
| 9 (stop) | ∞ | (variable) | | |
| 10 | −56.659 | 4.77 | 1.49700 | 81.7 |
| 11 | −7.032 | 0.68 | 1.62205 | 41.1 |
| 12 | 526.147 | 0.15 | | |
| 13 | 18.534 | 5.56 | 1.48749 | 70.2 |
| 14 | −15.007 | 5.66 | | |
| 15* | −11.969 | 1.81 | 1.53500 | 56.0 |
| 16* | −12.867 | (variable) | | |
| 17 | −66.711 | 1.79 | 1.48749 | 70.2 |
| 18 | −32.785 | 12.00 | | |
| Image | ∞ | | | |
| plane | | | | |

Aspherical surface data

Fifteenth surface
K = 1.30951e−02, A4 = −2.61233e−05, A6 = 6.86185e−06, A8 = −1.33121e−07,
A10 = 1.69154e−09, A12 = −1.26517e−11
Sixteenth surface
K = 0.00000e+00, A4 = 1.07609e−04, A6 = 4.74435e−06, A8 = −4.54631e−08,
A10 = 3.34596e−10, A12 = −2.30579e−12

Various data

| Object distance | Infinity | Closest |
|---|---|---|
| Focal length | 12.32 | |
| F-number | 2.88 | |
| Half angle of view | 43.96 | |
| Image height | 13.66 | |
| Total lens length | 63.50 | |
| BF | 12.00 | |
| d9 | 4.98 | 2.16 |
| d16 | 3.93 | 6.75 |

Lens unit data

| Unit | Start surface | Focal length |
|---|---|---|
| 1 | 1 | 43.56 |
| 2 | 10 | 32.53 |
| 3 | 17 | 130.00 |

[Numerical example 3]
Units: mm
Surface data

| Surface | | | | |
|---|---|---|---|---|
| number | rₘ | dₘ | ndₘ | νdₘ |
| 1 | 15.886 | 1.20 | 1.61997 | 63.9 |
| 2 | 7.746 | 3.86 | | |
| 3 | 29.749 | 1.51 | 1.49700 | 81.7 |
| 4 | 8.131 | 2.54 | | |
| 5 | 138.942 | 4.00 | 1.80610 | 40.7 |
| 6 | −24.233 | 4.19 | | |
| 7 | −18.756 | 2.32 | 1.51633 | 64.1 |
| 8 | −9.210 | 1.50 | | |
| 9 (stop) | ∞ | (variable) | | |
| 10 | 219.015 | 4.18 | 1.51633 | 64.1 |
| 11 | −7.464 | 1.20 | 1.80518 | 25.4 |
| 12 | −58.332 | 0.15 | | |
| 13 | −669.052 | 5.10 | 1.67270 | 32.1 |
| 14 | −11.446 | 4.06 | | |
| 15* | −9.250 | 1.50 | 1.53500 | 56.0 |
| 16* | −12.467 | (variable) | | |
| Image | ∞ | | | |
| plane | | | | |

Aspherical surface data

Fifteenth surface
K = 0.00000e+00, A4 = 2.57866e−04, A6 = −5.92436e−07, A8 = 2.32606e−08,
A10 = −2.39480e−10
Sixteenth surface
K = 0.00000e+00, A4 = 2.56479e−04, A6 = −5.75800e−07, A8 = 7.99259e−09,
A10 = −1.20784e−10

Various data

| Object distance | Infinity | Closest |
|---|---|---|
| Focal length | 15.77 | |
| F-number | 2.88 | |
| Half angle of view | 40.90 | |
| Image height | 13.66 | |
| Total lens length | 62.50 | |
| BF | 20.00 | 21.46 |
| d9 | 5.19 | 3.72 |
| d16 | 20.00 | 21.46 |

Lens unit data

| Unit | Start surface | Focal length |
|---|---|---|
| 1 | 1 | 41.39 |
| 2 | 10 | 36.00 |

[Numerical example 4]
Units: mm
Surface data

| Surface | | | | |
|---|---|---|---|---|
| number | rₘ | dₘ | ndₘ | νdₘ |
| 1 | −21.639 | 0.70 | 1.58913 | 61.1 |
| 2 | 14.601 | 1.94 | | |
| 3 | 115.762 | 2.70 | 2.00100 | 29.1 |
| 4 | −17.394 | 0.48 | | |
| 5 | −14.340 | 1.00 | 1.84666 | 23.8 |
| 6 | 104.892 | 0.15 | | |
| 7 | 32.292 | 3.99 | 1.80400 | 46.6 |
| 8 | −17.804 | 3.97 | | |
| 9 (stop) | ∞ | (variable) | | |
| 10 | −21.742 | 4.78 | 1.49700 | 81.7 |
| 11 | −7.299 | 0.80 | 1.51742 | 52.4 |
| 12 | 143.111 | 0.15 | | |
| 13 | 19.237 | 5.76 | 1.48749 | 70.2 |
| 14 | −19.417 | 4.00 | | |
| 15* | −31.371 | 2.00 | 1.53500 | 56.0 |
| 16* | −59.192 | (variable) | | |
| Image | ∞ | | | |
| plane | | | | |

Aspherical surface data

Fifteenth surface
K = 0.00000e+00, A4 = −4.59756e−06, A6 = −5.38359e−07, A8 = 2.93932e−09,
A10 = −4.00457e−11
Sixteenth surface
K = 0.00000e+00, A4 = 7.52901e−05

Various data

| Object distance | Infinity | Closest |
|---|---|---|
| Focal length | 27.16 | |
| F-number | 2.83 | |
| Half angle of view | 25.94 | |
| Image height | 13.66 | |
| Total lens length | 62.20 | |
| BF | 21.88 | 26.77 |
| d9 | 7.89 | 3.00 |
| d16 | 21.88 | 26.77 |

Lens unit data

| Unit | Start surface | Focal length |
|---|---|---|
| 1 | 1 | 44.78 |
| 2 | 10 | 57.59 |

[Numerical example 5]
Units: mm
Surface data

| Surface | | | | |
|---|---|---|---|---|
| number | rₘ | dₘ | ndₘ | νdₘ |
| 1 | 23.068 | 1.20 | 1.95375 | 32.3 |
| 2 | 8.858 | 4.12 | | |
| 3 | 70.483 | 0.80 | 1.49700 | 81.7 |
| 4 | 9.403 | 4.90 | | |
| 5 | 95.382 | 3.01 | 1.85883 | 30.0 |
| 6 | −32.448 | 3.81 | | |
| 7 | −98.802 | 3.51 | 1.56883 | 56.4 |
| 8 | −13.054 | 1.50 | | |
| 9 (stop) | ∞ | (variable) | | |
| 10 | 150.421 | 4.01 | 1.49700 | 81.7 |
| 11 | −8.440 | 0.80 | 1.85478 | 24.8 |
| 12 | −20.921 | 3.05 | | |
| 13 | −14.676 | 1.93 | 1.48749 | 70.2 |
| 14 | −10.097 | 4.02 | | |
| 15* | −104.288 | 1.98 | 1.53500 | 56.0 |
| 16* | −32.566 | (variable) | | |
| Image | ∞ | | | |
| plane | | | | |

Aspherical surface data

Fifteenth surface
K = 0.00000e+00, A4 = −4.73505e−06, A6 = −1.77181e−08, A8 = −1.40397e−09,
A10 = −2.94384e−11
Sixteenth surface
K = 0.00000e+00, A4 = 9.10902e−05, A6 = −7.46501e−09, A8 = 4.83577e−09,
A10 = −4.89018e−11

Various data

| Object distance | Infinity | Closest |
|---|---|---|
| Focal length | 11.33 | |
| F-number | 2.88 | |
| Half angle of view | 46.36 | |
| Image height | 13.66 | |
| Total lens length | 61.75 | |
| BF | 16.57 | 18.19 |
| d9 | 6.52 | 4.90 |
| d16 | 16.57 | 18.19 |

Lens unit data

| Unit | Start surface | Focal length |
|---|---|---|
| 1 | 1 | 25.42 |
| 2 | 10 | 33.31 |

[Numerical example 6]
Units: mm
Surface data

| Surface | | | | |
|---|---|---|---|---|
| number | rₘ | dₘ | ndₘ | νdₘ |
| 1 | −39.972 | 0.70 | 1.51633 | 64.1 |
| 2 | 11.358 | 2.27 | | |
| 3 | 83.463 | 4.06 | 1.95375 | 32.3 |
| 4 | −23.579 | 2.09 | | |
| 5 | −15.384 | 2.34 | 1.84666 | 23.8 |
| 6 | 89.940 | 0.15 | | |
| 7 | 40.666 | 3.56 | 1.88300 | 40.8 |
| 8 | −16.767 | 2.43 | | |
| 9 (stop) | ∞ | (variable) | | |
| 10 | −20.361 | 4.76 | 1.49700 | 81.7 |
| 11 | −7.310 | 0.80 | 1.51742 | 52.4 |
| 12 | 62.041 | 0.15 | | |
| 13 | 23.979 | 5.00 | 1.48749 | 70.2 |
| 14 | −19.453 | 4.00 | | |
| 15* | −4801.201 | 1.80 | 1.53500 | 56.0 |
| 16* | −82.153 | (variable) | | |
| Image | ∞ | | | |
| plane | | | | |

Aspherical surface data

Fifteenth surface
K = 0.00000e+00, A4 = −3.84759e−05, A6 = −2.54975e−07, A8 = 1.27102e−09,
A10 = −1.51523e−11
Sixteenth surface
K = 0.00000e+00, A4 = 1.45357e−05

Various data

| Object distance | Infinity | Closest |
|---|---|---|
| Focal length | 23.28 | |
| F-number | 2.83 | |
| Half angle of view | 28.46 | |
| Image height | 13.66 | |
| Total lens length | 63.20 | |
| BF | 20.54 | 26.08 |
| d9 | 8.54 | 3.00 |
| d16 | 20.54 | 26.08 |

Lens unit data

| Unit | Start surface | Focal length |
|---|---|---|
| 1 | 1 | 36.82 |
| 2 | 10 | 46.86 |

[Numerical example 7]
Units: mm
Surface data

| Surface | | | | |
|---|---|---|---|---|
| number | rₘ | dₘ | ndₘ | νdₘ |
| 1 | −18.699 | 0.60 | 1.51742 | 52.4 |
| 2 | 15.788 | 4.02 | | |
| 3 | 45.571 | 9.00 | 1.83481 | 42.7 |
| 4 | −19.428 | 0.55 | | |
| 5 (stop) | ∞ | (variable) | | |
| 6 | −13.024 | 0.91 | 1.75211 | 25.0 |
| 7 | −51.744 | 0.84 | | |
| 8 | 21.802 | 5.75 | 1.49700 | 81.7 |
| 9 | −19.593 | 0.19 | | |
| 10* | −63.603 | 5.02 | 1.53500 | 56.0 |
| 11* | −22.419 | (variable) | | |
| 12 | 108.711 | 0.85 | 1.53172 | 48.8 |
| 13 | 39.923 | 20.02 | | |
| Image | ∞ | | | |
| plane | | | | |

Aspherical surface data

Tenth surface
K = 0.00000e+00, A4 = 2.38175e−05, A6 = 4.52345e−07, A8 = −2.01259e−09,
A10 = 1.05760e−11, A12 = −1.99911e−13
Eleventh surface
K = 0.00000e+00, A4 = 9.68682e−05, A6 = 6.62446e−07, A8 = −4.39094e−09,
A10 = 1.06537e−10, A12 = −7.08731e−13

Various data

| Object distance | Infinity | Closest |
|---|---|---|
| Focal length | 22.66 | |
| F-number | 2.06 | |
| Half angle of view | 27.91 | |
| Image height | 12.00 | |
| Total lens length | 60.96 | |
| BF | 20.02 | |
| d5 | 7.15 | 3.95 |
| d11 | 6.06 | 9.26 |

Lens unit data

| Unit | Start surface | Focal length |
|---|---|---|
| 1 | 1 | 41.51 |
| 2 | 6 | 35.94 |
| 3 | 12 | −119.17 |

[Numerical example 8]
Units: mm
Surface data

| Surface | | | | |
|---|---|---|---|---|
| number | rₘ | dₘ | ndₘ | νdₘ |
| 1 | ∞ | 1.50 | | |
| 2 | 17.460 | 1.20 | 1.58913 | 61.1 |
| 3 | 8.203 | 4.14 | | |
| 4 | 28.883 | 1.51 | 1.49700 | 81.7 |
| 5 | 7.652 | 2.35 | | |
| 6 | 61.637 | 4.00 | 1.80400 | 46.6 |
| 7 | −26.181 | 3.94 | | |
| 8 | −22.850 | 2.37 | 1.51633 | 64.1 |
| 9 | −9.224 | 1.50 | | |
| 10 (stop) | ∞ | (variable) | | |
| 11 | −160.364 | 4.10 | 1.51633 | 64.1 |
| 12 | −7.374 | 1.20 | 1.76182 | 26.5 |
| 13 | −587.099 | 0.15 | | |
| 14 | −1982.237 | 4.58 | 1.72047 | 34.7 |
| 15 | −10.861 | 2.95 | | |
| 16* | −9.224 | 1.50 | 1.58313 | 59.4 |
| 17* | −11.974 | (variable) | | |
| Image | ∞ | | | |
| plane | | | | |

Aspherical surface data

Sixteenth surface
K = 0.00000e+00, A4 = −5.84907e−05, A6 = 4.16087e−06, A8 = −3.77842e−08,
A10 = 1.73448e−10
Seventeenth surface
K = 0.00000e+00, A4 = −4.06831e−06, A6 = 2.73342e−06, A8 = −2.20246e−08,
A10 = 5.44826e−11

Various data

| Object distance | Infinity | Closest |
|---|---|---|
| Focal length | 15.96 | |
| F-number | 2.88 | |
| Half angle of view | 40.60 | 40.40 |
| Image height | 13.66 | |
| Total lens length | 62.05 | |
| BF | 20.00 | 21.72 |
| d10 | 5.08 | 3.36 |
| d17 | 20.00 | 21.72 |

Lens unit data

| Unit | Start surface | Focal length |
|---|---|---|
| 1 | 1 | 30.32 |
| 2 | 11 | 38.79 |

[Numerical example 9]
Units: mm
Surface data

| Surface | | | | |
|---|---|---|---|---|
| number | rₘ | dₘ | ndₘ | νdₘ |
| 1 | −25.272 | 0.74 | 1.58913 | 61.1 |
| 2 | 13.157 | 3.16 | | |
| 3 | 73.056 | 5.50 | 1.80400 | 46.6 |
| 4 | −22.304 | 1.60 | | |
| 5 | −16.211 | 1.15 | 1.67270 | 32.1 |
| 6 | −30.124 | 0.15 | | |
| 7 | 166.672 | 4.54 | 1.59522 | 67.7 |
| 8 | −16.420 | 4.43 | | |
| 9 (stop) | ∞ | (variable) | | |
| 10 | −20.253 | 1.02 | 1.72825 | 28.5 |
| 11 | 153.658 | 0.15 | | |
| 12 | 26.023 | 4.89 | 1.65160 | 58.5 |
| 13 | −26.795 | 5.00 | | |
| 14* | −27.341 | 1.81 | 1.53500 | 56.0 |
| 15* | −19.433 | (variable) | | |
| Image | ∞ | | | |
| plane | | | | |

Aspherical surface data

Fourteenth surface
K = 0.00000e+00, A4 = 5.67295e−05, A6 = 1.77063e−07, A8 = 4.65930e−09,
A10 = −3.02196e−11
Fifteenth surface
K = 0.00000e+00, A4 = 1.35675e−04, A6 = 1.94246e−07, A8 = 7.07613e−09,
A10 = −3.29617e−11

Various data

| Object distance | Infinity | Closest |
|---|---|---|
| Focal length | 21.51 | |
| F-number | 2.00 | |
| Half angle of view | 30.17 | |
| Image height | 13.66 | |
| Total lens length | 61.41 | |
| BF | 20.00 | 23.71 |
| d9 | 7.25 | 3.54 |
| d15 | 20.00 | 23.71 |

Lens unit data

| Unit | Start surface | Focal length |
|---|---|---|
| 1 | 1 | 33.62 |
| 2 | 10 | 51.58 |

TABLE 1-1

| Inequality | Ex. 1 | Ex. 2 | Ex. 3 | Ex. 4 | Ex. 5 |
|---|---|---|---|---|---|
| (1) 1.45 < Nave2 < 1.67 | 1.535 | 1.535 | 1.632 | 1.509 | 1.594 |
| (1a) 1.47 < Nave2 < 1.66 | | | | | |
| (1b) 1.50 < Nave2 < 1.65 | | | | | |
| (2) −0.80 < f2/f2lp < 0.60 | 0.012 | −0.030 | −0.450 | −0.450 | 0.380 |
| (2a) −0.70 < f2/f2lp < 0.59 | | | | | |
| (2b) −0.60 < f2/f2lp < 0.58 | | | | | |
| (3) 2.20 < TD/f < 5.50 | 5.067 | 5.155 | 3.964 | 2.290 | 5.450 |
| (3a) 2.23 < TD/f < 5.48 | | | | | |
| (3b) 2.26 < TD/f < 5.46 | | | | | |
| (4) 0.60 < SPD/TD < 0.80 | 0.652 | 0.651 | 0.662 | 0.760 | 0.630 |
| (4a) 0.61 < SPD/TD < 0.79 | | | | | |
| (4b) 0.62 < SPD/TD < 0.78 | | | | | |
| (5) 1.50 < f2/f < 3.00 | 2.320 | 2.641 | 2.283 | 2.120 | 2.940 |
| (5a) 1.53 < f2/f < 2.98 | | | | | |
| (5b) 1.56 < f2/f < 2.96 | | | | | |
| (6) 0.20 < f1r/f1 < 1.10 | 0.817 | 0.708 | 0.829 | 0.330 | 1.025 |
| (6a) 0.25 < f1r/f1 < 1.07 | | | | | |
| (6b) 0.30 < f1r/f1 < 1.04 | | | | | |
| (7) 0.50 < f1/f2 < 2.00 | 1.519 | 1.339 | 1.149 | 0.778 | 0.763 |
| (7a) 0.55 < f1/f2 < 1.80 | | | | | |
| (7b) 0.60 < f1/f2 < 1.60 | | | | | |
| (8) −3.00 < (Rn2 + Rn1)/ | −1.779 | −2.225 | −2.817 | −0.194 | −2.247 |
| (Rn2 − Rn1) < −0.01 | | | | | |
| (8a) −2.95 < (Rn2 + Rn1)/ | | | | | |
| (Rn2 − Rn1) < −0.03 | | | | | |
| (8b) −2.90 < (Rn2 + Rn1)/ | | | | | |
| (Rn2 − Rn1) < −0.05 | | | | | |
| (9) 1.40 < f1/f < 3.70 | 3.524 | 3.536 | 2.622 | 1.649 | 2.244 |
| (9a) 1.45 < f1/f < 3.65 | | | | | |
| (9b) 1.50 < f1/f < 3.60 | | | | | |
| (10) 0.05 < DF/TD < 0.18 | 0.080 | 0.078 | 0.083 | 0.127 | 0.106 |
| (10a) 0.06 < DF/TD < 0.17 | | | | | |
| (10b) 0.07 < DF/TD < 0.16 | | | | | |
| (11) 0.15 < SK/TD < 0.46 | 0.330 | 0.189 | 0.343 | 0.430 | 0.295 |
| (11a) 0.16 < SK/TD < 0.45 | | | | | |
| (11b) 0.17 < SK/TD < 0.44 | | | | | |
| (12) 0.10 < Db1/TD < 0.24 | 0.131 | 0.122 | 0.144 | 0.135 | 0.138 |
| (12a) 0.11 < Db1/TD < 0.22 | | | | | |
| (12b) 0.12 < Db1/TD < 0.20 | | | | | |
| (13) 0.10 < Db2/TD < 0.26 | 0.213 | 0.202 | 0.192 | 0.215 | 0.141 |
| (13a) 0.11 < Db2/TD < 0.24 | | | | | |
| (13b) 0.12 < Db2/TD < 0.22 | | | | | |
| (14) 0.80 < d < 3.10 | 1.010 | 1.010 | 1.010 | 1.010 | 1.010 |
| (14a) 0.90 < d < 3.08 | | | | | |
| (14b) 1.00 < d < 3.06 | | | | | |

TABLE 1-2

| Inequality | EX. 6 | EX. 7 | EX. 8 | EX. 9 |
|---|---|---|---|---|
| (1) 1.45 < Nave2 < 1.67 | 1.509 | 1.595 | 1.645 | 1.638 |
| (1a) 1.47 < Nave2 < 1.66 | | | | |
| (1b) 1.50 < Nave2 < 1.65 | | | | |
| (2) −0.80 < f2/f2lp < 0.60 | 0.300 | 0.579 | −0.450 | 0.444 |
| (2a) −0.70 < f2/f2lp < 0.59 | | | | |
| (2b) −0.60 < f2/f2lp < 0.58 | | | | |
| (3) 2.20 < TD/f < 5.50 | 2.715 | 2.690 | 3.795 | 2.855 |
| (3a) 2.23 < TD/f < 5.48 | | | | |
| (3b) 2.26 < TD/f < 5.46 | | | | |
| (4) 0.60 < SPD/TD < 0.80 | 0.721 | 0.768 | 0.653 | 0.654 |
| (4a) 0.61 < SPD/TD < 0.79 | | | | |
| (4b) 0.62 < SPD/TD < 0.78 | | | | |
| (5) 1.50 < f2/f < 3.00 | 2.013 | 1.586 | 2.431 | 2.398 |
| (5a) 1.53 < f2/f < 2.98 | | | | |
| (5b) 1.56 < f2/f < 2.96 | | | | |
| (6) 0.20 < f1r/f1 < 1.10 | 0.376 | 0.420 | 0.933 | 0.754 |
| (6a) 0.25 < f1r/f1 < 1.07 | | | | |
| (6b) 0.30 < f1r/f1 < 1.04 | | | | |
| (7) 0.50 < f1/f2 < 2.00 | 0.786 | 1.155 | 0.782 | 0.652 |
| (7a) 0.55 < f1/f2 < 1.80 | | | | |
| (7b) 0.60 < f1/f2 < 1.60 | | | | |
| (8) −3.00 < (Rn2 + Rn1)/ | −0.557 | −0.084 | −2.772 | −0.315 |
| (Rn2 − Rn1) < −0.01 | | | | |
| (8a) −2.95 < (Rn2 + Rn1)/ | | | | |
| (Rn2 − Rn1) < −0.03 | | | | |
| (8b) −2.90 < (Rn2 + Rn1)/ | | | | |
| (Rn2 − Rn1) < −0.05 | | | | |
| (9) 1.40 < f1/f < 3.70 | 1.582 | 1.832 | 1.900 | 1.563 |
| (9a) 1.45 < f1/f < 3.65 | | | | |
| (9b) 1.50 < f1/f < 3.60 | | | | |
| (10) 0.05 < DF/TD < 0.18 | 0.135 | 0.117 | 0.084 | 0.118 |
| (10a) 0.06 < DF/TD < 0.17 | | | | |
| (10b) 0.07 < DF/TD < 0.16 | | | | |
| (11) 0.15 < SK/TD < 0.46 | 0.413 | 0.328 | 0.359 | 0.386 |
| (11a) 0.16 < SK/TD < 0.45 | | | | |
| (11b) 0.17 < SK/TD < 0.44 | | | | |
| (12) 0.10 < Db1/TD < 0.24 | 0.169 | 0.157 | 0.150 | 0.194 |
| (12a) 0.11 < Db1/TD < 0.22 | | | | |
| (12b) 0.12 < Db1/TD < 0.20 | | | | |
| (13) 0.10 < Db2/TD < 0.26 | 0.196 | 0.192 | 0.188 | 0.126 |
| (13a) 0.11 < Db2/TD < 0.24 | | | | |
| (13b) 0.12 < Db2/TD < 0.22 | | | | |
| (14) 0.80 < d < 3.10 | 1.010 | 1.010 | 1.010 | 2.820 |
| (14a) 0.90 < d < 3.08 | | | | |
| (14b) 1.00 < d < 3.06 | | | | |

According to the present disclosure, it is possible to provide an optical system which is provided with a lightweight focusing unit which is quiet and less likely to vibrate so as to be suitable for picking-up a moving image, and which has a high optical performance capable of satisfactorily correcting various aberrations including a lateral chromatic aberration and a field curvature, and an image pickup apparatus including the optical system.

### [Image Pickup Apparatus]

Next, an image pickup apparatus including a solid-state image pickup element that pickup an image formed by the optical system L0 according to any one of Examples 1 to 9 is described.

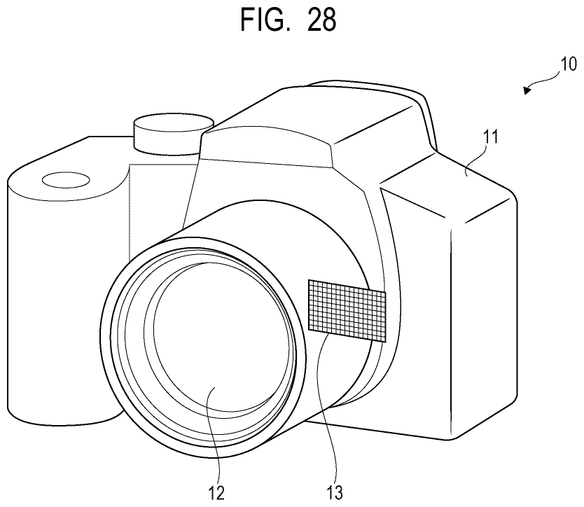

FIG. 28 shows a schematic perspective view of a digital camera 10 (image pickup apparatus) using the optical system L0 according to any one of Examples 1 to 9 as an image pickup optical system 12.

The digital camera 10 includes a camera body 11, the image pickup optical system 12 formed by the optical system L0 according to any one of Examples 1 to 9, and an image pickup element 13.

Specifically, the image pickup element 13 is a solid-state image pickup element (photoelectric conversion element) which is built in the camera body 11 and is configured to receive light from an object to pickup an image thereof formed by the image pickup optical system 12.

More specifically, the image pickup element 13 is formed by a charge coupled device (CCD) sensor, a complementary metal oxide semiconductor (CMOS) sensor, or the like, for example.

The optical system L0 according to any one of Examples 1 to 9 can be used as the image pickup optical system in a so-called single-lens reflex camera having a quick return mirror, a so-called mirrorless camera having no quick return mirror, or the like. Further, the optical system L0 according to any one of Examples 1 to 9 can also be used as the image pickup optical system in a monitoring camera, a video camera, or the like.

The digital camera 10 using the optical system L0 according to any one of Examples 1 to 9 as the image pickup optical system 12 is silent so as to be suitable for picking-up a moving image, and lightweight, and it is possible to perform image picking-up in which various aberrations are satisfactorily corrected by using it.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064387, filed Apr. 9, 2025, which is hereby incorporated by reference herein in its entirety.

What is claimed is:

1. An optical system comprising, in order from an object side to an image side, a first lens unit which does not move during focusing and has a positive refractive power, and a second lens unit which moves on an optical axis during focusing and has a positive refractive power,
wherein only the second lens unit moves during focusing,
wherein a total number of lenses included in the optical system is nine or less,
wherein a negative lens is arranged closest to the object side in the first lens unit, and
wherein following inequalities are satisfied:
1.45<Nave2<1.67
−0.80<f2/f2lp<0.60
2.20<TD/f<5.50
where Nave2 represents an average value of refractive indices of all lenses included in the second lens unit with respect to a d-line, f2 represents a focal length of the second lens unit, f2lp represents a focal length of a first lens having a largest absolute value of the focal length among the all lenses included in the second lens unit, TD represents a total optical length of the optical system, and f represents a focal length of the optical system.

2. The optical system according to claim 1, further comprising an aperture stop, wherein a following inequality is satisfied:
0.60<SPD/TD<0.80
where SPD represents a distance on the optical axis between the aperture stop and an image plane.

3. The optical system according to claim 1, wherein a following inequality is satisfied:
1.50<f2/f<3.00.

4. The optical system according to claim 1, wherein a following inequality is satisfied:
0.20<f1r/f1<1.10
where f1 represents a focal length of the first lens unit, and f1r represents a focal length of a lens arranged closest to the image side in the first lens unit.

5. The optical system according to claim 1, wherein a following inequality is satisfied:
0.50<f1/f2<2.00
where f1 represents a focal length of the first lens unit.

6. The optical system according to claim 1, wherein a following inequality is satisfied:
−3.00<(Rn2+Rn1)/(Rn2−Rn1)<−0.01
where Rn1 and Rn2 represent curvature radii of a lens surface on the object side and a lens surface on the image side in the negative lens, respectively.

7. The optical system according to claim 1, wherein a following inequality is satisfied:
1.40<f1/f<3.70
where f1 represents a focal length of the first lens unit.

8. The optical system according to claim 1, wherein a following inequality is satisfied:
0.05<DF/TD<0.18
where DF represents a distance on the optical axis between a lens surface on the object side in a second lens arranged closest to the object side in the second lens unit and a lens surface on the image side in a lens arranged adjacent to the object side of the second lens, or a distance on the optical axis between the lens surface on the object side in the second lens and an aperture stop in case that the aperture stop arranged adjacent to the object side of the second lens is provided, when focusing on infinity.

9. The optical system according to claim 1, wherein a following inequality is satisfied:
0.15<SK/TD<0.46
where SK represents an air-equivalent distance on the optical axis between a lens surface on the image side in a lens arranged closest to the image side in the optical system and an image plane.

10. The optical system according to claim 1, wherein a following inequality is satisfied:
0.10<Db1/TD<0.24
where Db1 represents a sum of lens thicknesses on the optical axis of lenses included in the first lens unit.

11. The optical system according to claim 1, wherein a following inequality is satisfied:
0.10<Db2/TD<0.26
where Db2 represents a sum of lens thicknesses on the optical axis of lenses included in the second lens unit.

12. The optical system according to claim 1, wherein a following inequality is satisfied:
0.80<d<3.10
where d represents a specific gravity of the first lens.

13. The optical system according to claim 1, wherein a number of lenses included in the second lens unit is four or less.

14. The optical system according to claim 1, wherein a number of lenses included in the optical system is six or more.

15. The optical system according to claim 1, wherein the first lens is arranged closest to the image side in the second lens unit.

16. An image pickup apparatus, comprising:
an optical system; and
an image pickup element configured to receive light from the optical system,
wherein the optical system includes, in order from an object side to an image side, a first lens unit which does not move during focusing and has a positive refractive power, and a second lens unit which moves on an optical axis during focusing and has a positive refractive power,
wherein only the second lens unit moves during focusing,
wherein a total number of lenses included in the optical system is nine or less,
wherein a negative lens is arranged closest to the object side in the first lens unit, and
wherein following inequalities are satisfied:
1.45<Nave2<1.67
−0.80<f2/f2lp<0.60
2.20<TD/f<5.50
where Nave2 represents an average value of refractive indices of all lenses included in the second lens unit with respect to a d-line, f2 represents a focal length of the second lens unit, f2lp represents a focal length of a first lens having a largest absolute value of the focal length among the all lenses included in the second lens unit, TD represents a total optical length of the optical system, and f represents a focal length of the optical system.
